(19) United States
(12) Patent Application Publication
(10) Pub. No.: US 2026/0188112 A1
(43) Pub. Date: Jul. 2, 2026

(54) SYSTEM AND METHOD FOR IDENTIFYING DIRECTION OF EXTERNAL SOUND AND DETERMINING ACTION

(71) Applicant: VOLVO Car Corporation, Gothenburg (SE)

(72) Inventors: Victor GUSTAFSON, Gothenburg (SE); Henrik KLARS, Gothenburg (SE); Michael ZÄCH, Gothenburg (SE); Magnus AXELSSON, Gothenburg (SE)

(73) Assignee: VOLVO Car Corporation, Gothenburg (SE)

(21) Appl. No.: 19/006,378

(22) Filed: Dec. 31, 2024

(51) Int. Cl. G08G 1/0965; G08G 1/01; G08G 1/017; H04R 1/32

(52) U.S. Cl. CPC G08G 1/0965; G08G 1/0112; G08G 1/017; H04R 1/326; H04R 2499/13

(57) ABSTRACT

A system is described. The system comprises: one or more sensors, and a processor. The processor storing instructions in a non-transitory memory that, when executed, cause the processor to: monitor, using the sensors, for an external sound matching with at least one from a predetermined set of sounds, configured to generate an alert signal to a driver of a host vehicle; identify the external sound and a target vehicle corresponding to the external sound; determine a direction and a location of the target vehicle with respect to the host vehicle; generate a display of the direction and the location of the target vehicle on screens of the host vehicle; update, continuously, the direction and the location of the target vehicle; predict a future location of the target vehicle; generate the alert signal to alert the driver for the target vehicle; and determine an action for the host vehicle.

### FIELD OF THE INVENTION

The present disclosure relates generally to vehicle safety systems. More specifically, the present disclosure relates to systems and methods for identifying direction of external sound and determining an action.

### BACKGROUND

In busy traffic environments, drivers are frequently exposed to various external sounds, such as emergency vehicle sirens, horns, or other sudden noises. These sounds often signal urgent situations, such as the approach of an ambulance, police vehicle, or an accident nearby. Timely recognition and response to these sounds are critical for ensuring road safety. However, drivers often face difficulty in accurately determining the direction and location of these sounds due to the complexity of auditory perception in noisy or congested environments. The delay in identifying the source of the sound can lead to incorrect or delayed responses, which may increase the risk of accidents or cause additional hazards on the road.

Therefore, there is a need for a system and a method of identifying the direction of external sound and determining an action.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate identifying direction of external sound and determining action for a host vehicle.

In an aspect, a system is described. The system comprises: one or more sensors and a processor. The processor storing instructions in a non-transitory memory that, when executed, cause the processor to: monitor, using the sensors, for an external sound matching with at least one from a predetermined set of sounds, configured to generate an alert signal to a driver of a host vehicle; identify the external sound and a target vehicle corresponding to the external sound; determine, using the sensors, a direction and a location of the target vehicle with respect to the host vehicle, based on the external sound; generate a display of the direction and the location of the target vehicle on one or more screens of the host vehicle; update, continuously, the direction and the location of the target vehicle; predict a future location of the target vehicle; generate the alert signal to alert the driver for the target vehicle based on the direction, the location, and the future location; and determine an action for the host vehicle.

In one aspect, a method is described. The method comprises: monitoring, using one or more sensors, for an external sound matching with at least one from a predetermined set of sounds, configured to generate an alert signal to a driver of a host vehicle; identifying the external sound and a target vehicle corresponding to the external sound; determining, using the sensors, a direction and a location of the target vehicle with respect to the host vehicle, based on the external sound; generating a display of the direction and the location of the target vehicle on one or more screens of the host vehicle; updating, continuously, the direction and the location of the target vehicle; predicting a future location of the target vehicle; generating the alert signal to alert the driver for the target vehicle based on the direction, the location, and the future location of the target vehicle; and determining an action for the host vehicle.

In one aspect, a non-transitory computer-readable storage medium is described. The non-transitory computer-readable storage medium comprising instructions, which when executed by a processor causes: monitoring, using one or more sensors, an external sound matching with at least one from a predetermined set of sounds, configured to generate an alert signal to a driver of a host vehicle; identifying one of the external sound and a target vehicle corresponding to the external sound; determining, using the sensors, a direction and a location of the target vehicle with respect to the host vehicle, based on the external sound; generating a display of the direction and the location of the target vehicle on one or more screens of the host vehicle; updating, continuously, the direction and the location of the target vehicle; predicting a future location of the target vehicle; generating the alert signal to alert the driver for the target vehicle based on the direction, the location, and the future location of the target vehicle; and determining an action for the host vehicle.

In one aspect, a system is described. The system comprises: one or more sensors; a communication module; and a processor. The processor storing instructions in a non-transitory memory that, when executed, cause the processor to: receive, by a host vehicle via the communication module, a message transmitted by a target vehicle; identify a content of the message to determine at least one of a destination and a path of the target vehicle; determine, using the sensors, a direction and a location of the target vehicle with respect to the host vehicle based on an external sound corresponding to the target vehicle; generate a display of the direction and the location of the target vehicle on one or more screens of the host vehicle; update, continuously, the direction and the location of the target vehicle; predict a future location of the target vehicle; generate an alert signal to alert a driver of the host vehicle based on the direction, the location, and the future location of the target vehicle; and determine an action for the host vehicle.

### BRIEF DESCRIPTION OF THE FIGURES

These and other aspects of the present disclosure will now be described in more detail, with reference to the appended drawings showing exemplary embodiments of the present disclosure, in which:

FIG. 1 illustrates a block diagram of a system and components of the system according to one or more embodiments.

FIG. 2 is an illustration of a vehicle with various sensors, actuators, and systems according to one or more embodiments.

FIG. 3 shows a block diagram of electronic components of a vehicle according to an embodiment.

FIG. 4 illustrates a block diagram of a sound detection module of the system according to one or more embodiments.

FIG. 5 illustrates a block diagram of a target vehicle tracking module of the system according to one or more embodiments.

FIG. 6 illustrates a block diagram of a route prediction module of the system according to one or more embodiments.

FIG. 7 illustrates a block diagram of an action determination module of the system according to one or more embodiments.

FIG. 8 illustrates an interaction between a host vehicle and a target vehicle according to one or more embodiments.

FIG. 9 illustrates an exemplary diagram to detect a target vehicle using a radar chart with four quadrants according to one or more embodiments.

FIG. 10 illustrates a vehicle dashboard display that provides real-time data about an approaching emergency vehicle according to one or more embodiments.

FIG. 11 illustrates communicating information from the target vehicle to the host vehicle according to one or more embodiments.

FIG. 12 illustrates generating an action to change the lane of the host vehicle according to one or more embodiments.

FIGS. 13A-13B illustrate predicting a path of the target vehicle and an interaction location on the path where an interaction of the host vehicle and the target vehicle occurs according to one or more embodiments.

FIG. 14 shows an example block diagram for a machine learning model according to one or more embodiments.

FIG. 15 illustrates a system for identifying a direction of external sound and determining an action, according to one or more embodiments.

FIG. 16 illustrates a method for identifying a direction of external sound and determining an action, according to one or more embodiments.

FIG. 17 illustrates a method, stored in a non-transitory computer-readable storage medium, in a block diagram for identifying direction of external sound and determining an action, according to one or more embodiments.

FIG. 18 illustrates a system for communicating a message to a host vehicle by a target vehicle and determining an action according to one or more embodiments.

FIG. 19 illustrates a system for identifying the direction of external sound and performing an action, according to one or more embodiments.

FIG. 20 illustrates a method for identifying the direction of external sound and performing an action according to one or more embodiments.

FIG. 21 illustrates a non-transitory computer-readable storage medium for identifying the direction of external sound and performing an action according to one or more embodiments.

FIG. 22 illustrates a system for communicating a message to a host vehicle by a target vehicle and performing an action according to one or more embodiments.

FIG. 23A shows a structure of the neural network/machine learning model with a feedback loop.

FIG. 23B shows a structure of the neural network/machine learning model with reinforcement learning.

FIG. 24A shows a block diagram of the cyber security module in view of the system and server.

FIG. 24B shows an embodiment of the cyber security module.

FIG. 24C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein. Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a non-transitory computer-readable storage medium for execution by, or to control the operation of, data processing apparatus. The non-transitory computer-readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a stand-alone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Controller (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multiprocessor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “set of sounds” refers to a collection of specific sounds that may be used as reference signals for detection and identification. These sounds may include, but are not limited to, emergency vehicle sirens (e.g., ambulance, police, firetruck), vehicle horns, tire screeches, collision impacts, and other critical auditory cues.

As used herein, the term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

As used herein, the term “vehicle” as used herein refers to a thing used for transporting people or goods. Automobiles, cars, trucks, buses, etc., are examples of vehicles.

As used herein, the term “host vehicle” refers to a vehicle in a given scenario, typically an autonomous or semi-autonomous vehicle, that is actively monitoring and interacting with its surroundings. It is also referred to as an ego vehicle.

As used herein, the term “target vehicle” refers to any vehicle that is being monitored, tracked, or being interacted with by the host vehicle in a given scenario.

As used herein, the term “future location” refers to a location where a vehicle might be present at a future period of time.

As used herein, the term “action” refers to a response or adjustment made by the host vehicle.

As used herein, the term “sound type” refers to the specific category or classification of sound based on its unique acoustic profile.

As used herein, the term “acoustic characteristics” refers to the set of characteristics or parameters to recognize and differentiate between various sound types. These characteristics may include sound properties such as frequency, amplitude, pitch, duration, and pattern of the sound.

As used herein, the term “user interface” refers to the system's interactive platform that allows the driver or user to view information, receive alerts, and interact with the system.

As used herein, the term “override” refers to the feature that allows to bypass or override the actions initiated by the system. For example, override can be automatic or manual.

As used herein, the term “interaction location” refers to the specific point or area on the road where the paths of two vehicles, for example a host vehicle and a target vehicle, are predicted to converge or intersect.

As used herein, the term “resistance” refers to the system's automatic application of force or feedback that opposes and/or slows down a vehicle's motion in a specific direction.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, the term “computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein. The computer-readable storage medium can be a tangible device that can retain and store instructions for use by an instruction execution device. For example, the computer-readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer-readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD ROM), a digital versatile disk (DVD), a memory stick, a floppy disk, a mechanically encoded device such as punch-cards or raised structures in a groove having instructions recorded thereon and/or any suitable combination of the foregoing. A computer-readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer-readable program instructions described herein are downloadable to respective computing/processing devices from a computer-readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device. Computer-readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer-readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field programmable gate arrays (FPGA), and/or programmable logic arrays (PLA) can execute the computer-readable program instructions by utilizing state information of the computer-readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer-readable program instructions. These computer-readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

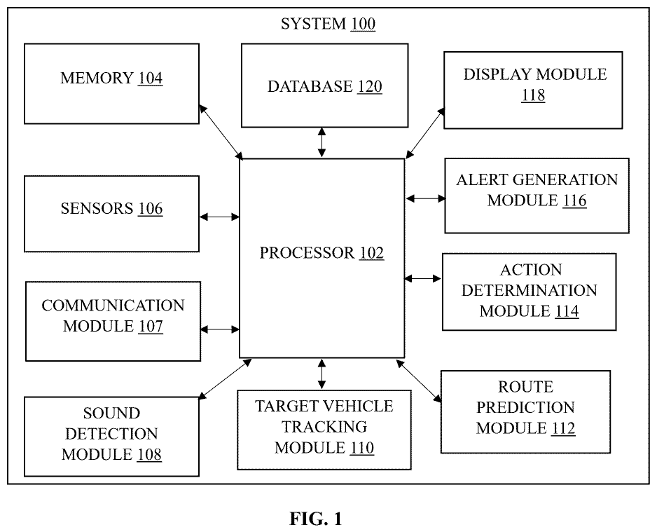

As an example, FIG. 1 illustrates a block diagram of a system 100 and components of the system according to one or more embodiments. The system 100 comprises a processor 102, memory 104, sensors 106, communication module 107, sound detection module 108, target vehicle tracking module 110, route prediction module 112, action determination module 114, alert generation module 116, display module 118, and database 120.

This description of modules, functions, and components is provided solely for illustrative purposes to aid in understanding the present disclosure. The specific division of tasks among the depicted modules is intended for explanation and convenience and should not be construed as a strict requirement that any particular module must exclusively perform a specific task or function. It is understood that various tasks, operations, and processing steps described herein may be performed by different modules, combined, omitted, or carried out in varying configurations without departing from the scope of the disclosure.

Processor 102 may be a high-performance, multi-core CPU or system-on-chip (SoC) solution to process vast amounts of data from various sensors that may be used. Processor 102 processes data from sensors, such as cameras, Light Detection and Ranging (LiDAR), radar, and other inputs to make real-time decisions, recommendations, and to execute control actions for the vehicle. Processor 102 may comprise Graphics Processing Units (GPUs). GPUs are utilized for their ability to accelerate tasks like image and sensor data processing. Some vehicles may incorporate Field Programmable Gate Arrays (FPGAs) to efficiently perform specialized computations, while others might leverage Application Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. Processor 102 may run sophisticated algorithms and artificial intelligence (AI) software to analyze sensor data, detect users, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor 102 interacts and exchanges data with one or more of the other components or modules of the system, for example, memory 104, sensors 106, communication module 107, sound detection module 108, target vehicle tracking module 110, route prediction module 112, action determination module 114, alert generation module 116, display module 118 and database 120.

Memory 104 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high speed operation and low power consumption. In an embodiment, memory 104 may be a Cloud-based memory. In another embodiment, the memory may be a local memory. In another embodiment, it may be a combination of local and Cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, Cloud-based memory relies on remote servers and services provided by third-party Cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions.

The host vehicle receives a message transmitted by the target vehicle via communication module 107. The system identifies the content of the message to determine at least one of a destination and a path of the target vehicle. The system may use a Natural Language Processing (NLP) model for identifying the content of the message. In an embodiment, the message further comprises one or more of the direction of the target vehicle, and the location of the target vehicle. The NLP model may receive the message transmitted by the target vehicle, which comprises information such as the destination, and path of the target vehicle. Upon receiving the message, the NLP model processes the message by analyzing textual content or data format within the message. The NLP model extracts specific entities or pieces of information to understand the target vehicle's behavior and movement. Upon extracting the specific entities, the NLP model may recognize the destination (e.g., a set of coordinates, address, or place), the path (e.g., a route or trajectory), and other contextual details such as the target vehicle's current speed and heading vector. In an embodiment, the message comprises data like: “Target vehicle is heading to 45.4215° N, 75.6992° W at 60 mph”. The NLP model would extract the destination (45.4215° N, 75.6992° W) and speed (60 mph) as separate entities. After recognizing the relevant entities, the NLP model classifies them based on their type and purpose. In an embodiment, the destination may be categorized as a geographical location or set of Global Positioning System (GPS) coordinates, while the path might be identified as a route pattern. Once classified, the NLP model extracts the necessary data components from the message. This could involve converting raw GPS coordinates into a readable format or transforming route data into waypoints. After processing and extracting the relevant data, the NLP model sends this information to processor 102. Processor 102 can use the extracted information to predict the target vehicle's future location based on its current path, speed, and direction. System 100 then generates a display of the direction and the location of the target vehicle on one or more screens of the host vehicle.

Sound detection module 108 monitors an external sound matching with at least one from a predetermined set of sounds, configured to generate an alert signal to a driver of the host vehicle using sensors 106. In an embodiment, the external sound comprises a siren; and the siren comprises a pattern associated with one or more of an ambulance, a fire truck, an emergency vehicle, and a police vehicle. The external sound matching may comprise the detection and identification of the external sound that corresponds to a predefined set of sounds stored within database 120. The predefined set of sounds may comprise a type of sounds such as emergency vehicle sirens (e.g., ambulance, police, firetruck sirens), car horns, tire screeches, crash impacts, or other audible signals that are associated with different types of vehicles or situations. Sensors 106 may comprise one or more of a microphone, an acoustic sensor, an ultrasonic sensor, a vibrations sensor, a pressure sensor, a radar sensor, and a LiDAR sensor. Sensors 106 may be an IR sensor, and an image sensor.

Sound detection module 108 processes the external sound captured by the sensors 106 and identifies the external sound and a target vehicle corresponding to the external sound. Sound detection module 108 identifies and classifies these sound types to determine the nature of the external sound and its potential relevance to the host vehicle. In an embodiment, the system 100 comprises a machine learning module configured to identify the external sound. The machine learning module identifies the external sound by identifying a sound type associated with the target vehicle based on predefined acoustic characteristics. Sound detection module 108 uses these predefined acoustic characteristics as a reference to match detected external sounds with known sound types, enabling identification of the target vehicle.

Machine learning module may continuously update the predefined acoustic characteristics based on historical sound data and new data comprising environmental conditions to improve an accuracy of identification of the external sound. The historical sound data may comprise previously collected and stored audio recordings and acoustic profiles of external sounds, such as emergency sirens, horns, or crash noises, which the system has encountered in past scenarios. This data is used by the machine learning module to train and refine the system's ability to identify sound types. Historical sound data may include examples of various sound types under different driving conditions, allowing the system to recognize patterns and improve over time. The new data may comprise audio and environmental information that the system continuously collects in real-time while the host vehicle is operating. This new data includes not only the current external sounds but also environmental conditions, such as background noise, traffic density, weather conditions (e.g., rain, wind), and surrounding road conditions. The system uses this new data to adapt and improve its accuracy in identifying external sounds by adjusting for factors that may affect sound detection, ensuring that it remains responsive to changing environments.

Machine learning module may adjust the sensitivity of detection of the external sound based on a current environmental noise level. Sensitivity of detection refers to the system's ability to recognize and respond to external sounds, particularly how easily the system can detect quieter or more distant sounds amidst varying levels of background noise. The current environmental noise level may be the level of ambient or background noise in the host vehicle's surroundings at a given time. This noise may originate from various sources, such as other vehicles, construction, wind, rain, or city sounds. The current environmental noise level can fluctuate based on the location (e.g., city streets vs. rural areas) and weather or traffic conditions.

Sound detection module 108 utilizes a frequency analysis and a pattern recognition algorithm to distinguish between the external sound and ambient noise, and the pattern recognition algorithm uses a combination of amplitude modulation, frequency modulation, and temporal sequence analysis.

In an embodiment, the frequency analysis is the process of analyzing the different frequency components within the external sound to differentiate it from ambient noise. Sound detection module 108 may analyze the sound waves, identifying the specific frequencies associated with predefined sound types (e.g., sirens, horns) and separating them from irrelevant background noise that may have different frequency characteristics.

In an embodiment, the pattern recognition algorithm is a computational method to identify the patterns within the detected external sounds. The algorithm compares these patterns to stored profiles of sound types, such as emergency sirens or crash noises, to recognize and classify them correctly.

The amplitude modulation may be variations in loudness or intensity of the external sound over time. The system analyzes how the amplitude (or volume) of the sound changes to identify patterns typical of certain sound types (e.g., the rising and falling intensity of a siren) while distinguishing them from ambient noise, which may have less regular amplitude fluctuations.

The frequency modulation may be changes in the pitch or frequency of the external sound over time. The system analyzes how the frequency of the sound shifts, such as the cyclical changes in pitch that may be characteristic of a police siren, and compares this modulation to known patterns to help identify the sound type.

The temporal sequence analysis may be the examination of the timing and duration of sound patterns. The system analyzes the order and spacing of sound events such as the intervals between siren wails or horn blasts to recognize specific sound types from ambient noise.

Target vehicle tracking module 110 determines the direction and location of the target vehicle relative to the host vehicle based on the external sound detected by sound detection module 108. Target vehicle tracking module 110 tracks the movement of the target vehicle to continuously update the position, location, and heading vector of the target vehicle based on the external sound captured by sensors 106. Target vehicle tracking module 110 determines the direction and the location of the target vehicle relative to the host vehicle by analyzing time delay and intensity of the external sound detected by sensors 106. Target vehicle tracking module 110 may use techniques such as triangulation which comprises comparing the arrival time of sound signals received at sensors 106, and can be used to estimate the direction and the location of the target vehicle. By processing the sound characteristics, target vehicle tracking module 110 can track the direction and the location of the target vehicle with respect to the host vehicle in real-time.

Target vehicle tracking module 110 updates the direction and the location of the target vehicle at a predetermined time interval. The predetermined time interval may be a fixed or pre-set period of time between consecutive updates of the direction and location of the target vehicle.

Route prediction module 112 predicts the future location of the target vehicle. Route prediction module 112 may use data from sensors 106 and target vehicle tracking module 110, which determines the direction and location of the target vehicle relative to the host vehicle.

By continuously analyzing a destination of the target vehicle, a path of the target vehicle, a current speed of the target vehicle, a current heading vector of the target vehicle, and current traffic data, route prediction module 112 determines the future location of the target vehicle. Route prediction module 112 might also factor in additional data, such as road network information, and environmental conditions. The destination of the target vehicle may be the intended or final location where the target vehicle is heading. This may be derived from navigation data, driver input, or inferred based on the direction and location of the target vehicle.

The path of the target vehicle may be the route or trajectory that the target vehicle is following or is predicted to follow to reach its destination. The path comprises the series of positions the vehicle has taken or is expected to take based on its current movement and navigation data.

The current speed of the target vehicle may be the present velocity at which the target vehicle is traveling. This is typically measured in units such as miles per hour (mph) or kilometers per hour (km/h) and can vary depending on traffic conditions or road regulations.

The current heading vector of the target vehicle may be the directional vector that represents the current direction in which the target vehicle is moving. The current heading vector is typically expressed in terms of degrees relative to a reference direction, such as North, and can indicate the vehicle's orientation and intended movement.

In an embodiment of the system, the current traffic data comprises real-time information about the traffic conditions surrounding the target vehicle. This data may include factors such as traffic congestion, road closures, speed limits, and incidents that could affect the target vehicle's movement and path.

Route prediction module 112 may use machine learning or statistical models to refine predictions based on real-time and historical data, improving the accuracy of future location estimates. Route prediction module 112 may combine this information with data from the sensors 106, such as the timing of sound arrival and its intensity, to predict how and when the target vehicle's path will intersect with the host vehicle's path. This allows the system to determine possible interaction locations where the host vehicle may need to take action to avoid a collision or unsafe interaction.

Action determination module 114 determines the action for the host vehicle in response to the information received from route prediction module 112. The action may be adjusting the speed or changing the lane of the host vehicle. Action determination module 114 determines the action such as adjusting the speed or changing the lane of the host vehicle based on urgency and traffic data. Action determination module 114 may also, in embodiments, dynamically suggest a change in the host vehicle's route. Once action determination module 114 determines the action, action determination module 114 informs the alert generation module 116 of the specific action the driver should consider or the anticipated hazard level. In an embodiment, the host vehicle prioritizes the action based on urgency, which is determined by characteristics of the external sound, such as pattern, frequency modulation, volume intensity, and the type of the target vehicle.

Alert generation module 116 generates an alert signal for the driver based on the detected direction, location, and future movement of the target vehicle. The alert signal may include visual and auditory cues displayed on the dashboard or heads-up display to inform the driver of potential risks. The auditory cue may be any sound based alert or signal emitted by the system to notify the driver of the presence of a target vehicle, such as an emergency vehicle. The visual cue may be any graphical, symbolic, or visual indicator displayed to the driver on the vehicle's dashboard, heads-up display (HUD), or any other visual interface. The visual cue may comprise arrows, flashing lights, icons, color changes, or quadrant highlights that correspond to the direction, proximity, or nature of the detected target vehicle, such as an emergency vehicle. The auditory cue may comprise distinct tones, chimes, or spoken alerts that vary in intensity, frequency, or urgency depending on the proximity, type, and motion of the target vehicle.

Display module 118 generates a visual display of the direction and location of the target vehicle on one or more screens within the host vehicle, such as a dashboard display, heads-up display, or smartphone. In an embodiment, displaying the direction of the target vehicle comprises displaying the angle in one of front left quadrant, front right quadrant, rear right quadrant, and rear left quadrant.

In an embodiment, the visualization could be displayed as a radar positioning map which shows objects' positions relative to the radar source/sensors detecting the source, providing information about range, direction, speed, etc. A graphical display of detected objects may be marked as blips or markers on a circular interface that may represent the scanning area, often including distance markers from the sensors/source.

In an embodiment, the system 100 further enhances the sensors 106 upon identifying the external sound, and enhancing the sensors 106 comprises one or more of adjusting scan frequency, adjusting signal focus, adjusting focus on specific frequency bands, adjusting sensitivity of the sensors, adjusting resolution of the sensors, adjusting Automatic Gain Control of the sensors, adjusting real-time noise reduction, and dynamically adding and deleting sensor data for multi-modal sensor fusion. The scan frequency may be the rate at which the sensors capture or sample data, determining how often external sounds are analyzed. The signal focus may be the ability of the sensors to concentrate on a specific area or direction where the external sound originates, improving sound isolation.

In an embodiment, the frequency bands are the prioritization of certain ranges of sound frequencies present in the external sound, enhancing detection accuracy within those ranges. The sensitivity of the sensors may be the sensor's ability to detect and respond to variations in sound levels or frequencies in its environment. In an embodiment, the resolution of the sensor is the level of detail or precision in the data captured by the sensor, affecting the system's ability to distinguish between different sounds. In an embodiment of the system, the Automatic Gain Control (AGC) is the system's mechanism for automatically regulating the volume of incoming sound signals to maintain balanced levels for analysis. In an embodiment, the real-time noise reduction is the process of filtering out ambient or background noise during sensor operation, enabling clearer detection of relevant external sounds.

In an embodiment, the multi-modal sensor fusion may be the integration of data from multiple sensor types (e.g., microphones, cameras, radar) to provide a more comprehensive and accurate analysis of the external environment.

The functioning of sound detection module 108, target vehicle tracking module 110, route prediction module 112, and action determination module 114 is explained using the figures below.

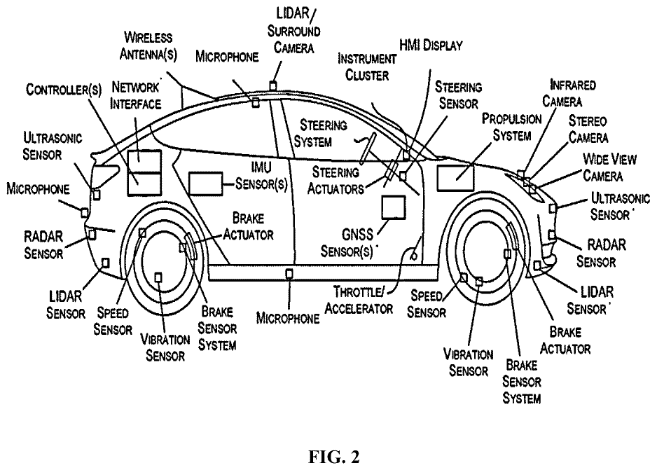

FIG. 2 is an illustration of a vehicle with various sensors, actuators, and systems according to one or more embodiments. The vehicle comprises various sensors, such as microphones, acoustic sensors, ultrasonic sensors, vibrations sensors, pressure sensors, radar sensors, LiDAR sensors, image sensors, IR sensors, etc. FIG. 2 is depicted as an example vehicle; neither is it limited by the sensors, actuators, and systems/subsystems, and/or features depicted nor is it an exhaustive list of the sensors, actuators, and systems/subsystems, and/or features of the vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the vehicle. In an embodiment, sensors comprise cameras, camera-based sensors, LiDARs, radars, optical sensors, laser sensors, speed sensors, motion sensors, and ultrasonic sensors enable autonomous vehicles to detect and recognize objects, obstacles, and pedestrians on the road.

In an embodiment, the sensors are activated to continuously monitor the external sounds and environmental data. In an embodiment, the sensors are activated to periodically monitor the external sounds and environmental data.

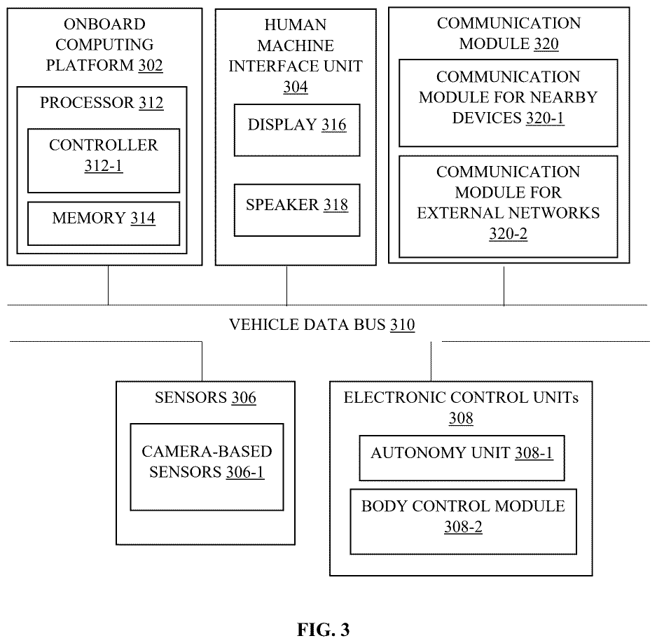

FIG. 3 shows a block diagram of electronic components of a vehicle according to an embodiment. In the illustrated example, the electronic components comprise an onboard computing platform 302, a human machine interface (HMI) unit 304, the communication module 320, sensors 306, electronic control units (ECUs) 308, and a vehicle data bus 310. The onboard computing platform 302 comprises a processor 312 (also referred to as a microcontroller unit or a controller) and memory 314. In the illustrated example, processor 312 of the onboard computing platform 302 is structured to include the controller 312-1. In an embodiment, the controller 312-1 is incorporated into another ECU with its own processor and memory. The processor 312 may be any suitable processing device or set of processing devices such as, but not limited to, a microprocessor, a microcontroller-based platform, an integrated circuit, one or more field programmable gate arrays (FPGAs), and/or one or more Application Specific Integrated Circuits (ASICs). The memory 314 may be volatile memory (e.g., RAM comprising non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid-state drives, etc.). In an embodiment, memory 314 includes multiple kinds of memory, particularly volatile memory, and non-volatile memory. Memory 314 is computer-readable media on which one or more sets of instructions, such as the software for operating the methods of the present disclosure, can be embedded. The instructions may embody one or more of the methods or logic as described herein. In an embodiment, the instructions reside completely, or at least partially, within any one or more of the memory 314, the computer-readable medium, and/or within the processor 312 during execution of the instructions.

The Human Machine Interface (HMI) unit 304 provides an interface between the vehicle and a user. The HMI unit 304 comprises digital and/or analog interfaces (e.g., input devices and output devices) to receive input from, and display information for, the user(s). In an embodiment, the input devices comprise a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, a display 316 (e.g., a heads-up display, a center console display such as a liquid crystal display (LCD), an organic light emitting diode (OLED) display, a flat panel display, a solid-state display, etc.), and/or a speaker 318. In an embodiment, the display 316, the speaker 318, and/or other input and output device(s) of the HMI unit 304 are operable to emit an alert, such as an alert to request manual takeover to an operator (e.g., a driver) of the vehicle. In an embodiment, the HMI unit 304 comprises hardware (e.g., a processor or controller, memory, storage, etc.) and software (e.g., an operating system, etc.) for an infotainment system that is presented via display 316.

Sensors 306 are arranged in and/or around the vehicle to monitor properties of the vehicle and/or an environment in which the vehicle is located. One or more of the sensors 306 may be mounted to measure properties around an exterior of the vehicle. Additionally, or alternatively, one or more of sensors 306 may be mounted inside a cabin of the vehicle or in a body of the vehicle (e.g., an engine compartment, wheel wells, etc.) to measure properties of the vehicle and/or interior sensing of the vehicle. In an embodiment, the sensors 306 comprise accelerometers, odometers, tachometers, pitch and yaw sensors, wheel speed sensors, microphones, tire pressure sensors, biometric sensors, ultrasonic sensors, infrared sensors, Light Detection and Ranging (LiDAR/lidar), Radio Detection and Ranging System (radar), Global Positioning System (GPS), millimeter wave (mmWave) sensors, cameras and/or sensors of any other suitable type. Sensors may comprise camera-based sensors 306-1 such as LiDAR, radar, cameras, ultrasonic sensors, GPS sensors, etc., configured for object detection/detecting distances between the vehicle and an object or target in its vicinity. In an embodiment, the one or more sensors associated with the vehicle comprises one or more of a magnetic sensor, a proximity sensor, a load sensor, an electrical sensor, and a vision sensor, a motion sensor, a temperature sensor, and a GPS sensor. In an embodiment, the one or more sensors associated with the vehicle comprises a camera coupled with a computer vision system.

The ECUs 308 monitor and control the subsystems of the vehicle. In an embodiment, the ECUs 308 are discrete sets of electronics that comprise their own circuit(s) (e.g., integrated circuits, microprocessors, memory, storage, etc.) and firmware, sensors, actuators, and/or mounting hardware. The ECUs 308 communicate and exchange information via a vehicle data bus (e.g., the vehicle data bus 310). Additionally, the ECUs 308 may communicate properties (e.g., status of the ECUs, sensor readings, control state, error, and diagnostic codes, etc.) and/or receive requests from each other. In an embodiment, the vehicle may have dozens of the ECUs that are positioned in various locations around the vehicle and are communicatively coupled by the vehicle data bus 310.

In an embodiment, the ECUs 308 comprise the autonomy unit 308-1 and a body control module 308-2. In an embodiment, the autonomy unit 308-1 is operable to perform autonomous and/or semi-autonomous driving maneuvers (e.g., defensive driving maneuvers) of the vehicle based upon, at least in part, instructions received from the controller 312-1 and/or data collected by the sensors 306 (e.g., object detection sensors). Further, the body control module 308-2 controls one or more subsystems throughout the vehicle, such as power windows, power locks, an immobilizer system, power mirrors, etc. In an embodiment, the body control module 308-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 310 communicatively couples the communication module 320, the onboard computing platform 302, the HMI unit 304, the sensors 306, and the ECUs 308. In an embodiment, the vehicle data bus 310 comprises one or more data buses. The vehicle data bus 310 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module for nearby devices 320-1 is operable to communicate with other nearby communication devices. In an embodiment, communication module 320 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 320-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. In an embodiment, a C-V2X module is operable to communicate with nearby devices (e.g., vehicles, roadside units, mobile devices, etc.) directly and/or via cellular networks. Currently, standards related to C-V2X communication are being developed by the 3rd Generation Partnership Project. Further, the communication module 320-2 is operable to communicate with external networks. In an embodiment, the communication module 320-2 comprises hardware (e.g., processors, memory, storage, antenna, etc.) and software to control wired or wireless network interfaces. In an embodiment, the communication module 320-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In an embodiment, the communication module for external networks 320-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In an embodiment, the vehicle may communicate with the external network via the coupled mobile device. The external network(s) may be a public network, such as the Internet; a private network, such as an intranet, or combinations thereof, and may utilize a variety of networking protocols now available or later developed including, but not limited to, TCP/IP-based networking protocols.

In an embodiment of the system, the Vehicle-to-Vehicle (V2V) communication is based on wireless communication protocols using at least one of a Dedicated Short-Range Communications (DSRC), and a Cellular Vehicle-to-Everything (C-V2X) technology. In an embodiment, the communication module is enabled for autonomous communication, and the autonomous communication comprises communication over a period with minimal supervision under different scenarios. The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 308-1 of the illustrated example is operable to perform autonomous and/or semi-autonomous driving maneuvers, such as defensive driving maneuvers, for the vehicle. In an embodiment, the autonomy unit 308-1 performs the autonomous and/or semi-autonomous driving maneuvers based on data collected by the sensors 306. In an embodiment, the autonomy unit 308-1 is operable to operate a fully autonomous system, a park-assist system, an advanced driver assistance system (ADAS), and/or other autonomous system(s) for the vehicle.

Further, in the illustrated example, controller (or control module) 312-1 is operable to monitor an ambient environment of the vehicle, to enable the autonomy unit 308-1 to perform autonomous and/or semi-autonomous driving maneuvers. The controller 312-1 collects data that is collected by sensors 306 of the vehicle. In an embodiment, the controller 312-1 collects location based data via the communication module 320-1 and/or another module (e.g., a GPS receiver) to facilitate the autonomy unit 308-1 in performing autonomous and/or semi-autonomous driving maneuvers. Additionally, the controller 312-1 collects data from (i) adjacent vehicle(s) via the communication module 320-1 and V2V communication and/or (ii) roadside unit(s) via the communication module 320-1 and V2I communication to further facilitate the autonomy unit 308-1 in performing autonomous and/or semi-autonomous driving maneuvers.

In an embodiment, controller 312-1 is operable to determine the takeover time of the adjacent vehicle based on measured characteristics of the vehicle and measured characteristics of the adjacent vehicle (e.g., velocity, acceleration, dimensions, etc.), the operator of the adjacent vehicle (e.g., a measured reaction time, etc.), and/or an environment of the adjacent vehicle (e.g., road conditions, weather conditions, etc.). Further, the time-to-collision corresponds with the time it would take for the adjacent vehicle to collide with another vehicle (e.g., a third vehicle) and/or object (e.g., a guardrail, a highway lane divider, etc.) if the current conditions were maintained.

In an embodiment, the vehicle-to-vehicle (V2V) communication is based on a wireless communication protocol using at least one of a Dedicated Short-Range Communications (DSRC), and a Cellular Vehicle-to-Everything (C-V2X) technology. In an embodiment, the V2X communication comprises at least one of a Vehicle-to-Network (V2N), Vehicle-to-Grid (V2G), Vehicle-to-Device (V2D), and Vehicle-to-Pedestrian (V2P). The system notifies nearby or surrounding vehicles or vehicles communicating with the vehicle's communication module.

In an embodiment, the vehicle may transmit a message via a communication link. It can be using any combination of vehicle-to-vehicle (V2V), vehicle-to-everything (V2X) or vehicle-to-infrastructure (V2I) type of communication.

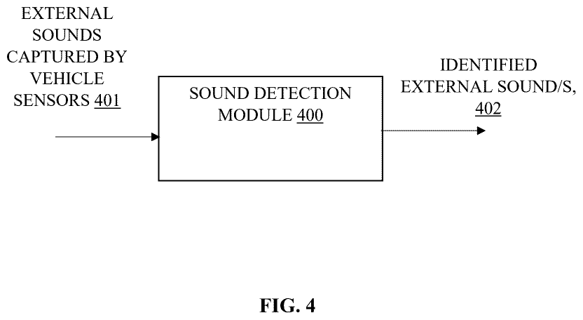

As an example, FIG. 4 illustrates a block diagram of sound detection module 400 according to one or more embodiments. Sound detection module 400 isolates specific sounds (e.g., sirens) by reducing or eliminating background noise such as traffic, wind, or engine sounds. In an embodiment, the input to the sound detection module 400 comprises external sounds 401 captured by sensors (e.g., microphones) and environmental noise data, such as background traffic or wind noise. In an embodiment, the output of the sound detection module 400 comprises filtered audio data that comprises the identified external sound 402 (such as sirens) while minimizing irrelevant audio signals. In an embodiment, if a microphone picks up both a siren and sounds of nearby traffic, the sound detection module 400 enhances the siren sound and reduces the traffic noise, providing filtered audio input for further analysis.

Further, sound detection module 400 analyzes the filtered audio to identify specific sounds associated with target vehicles. Sound detection module 400 may employ techniques such as frequency analysis and pattern recognition to classify and identify the type of sound captured. This comprises analyzing the sound's frequency content and using known patterns to match sounds with corresponding vehicle types. Sound detection module 400 may provide identified external sound 402 (e.g., “ambulance siren” or “fire truck siren”) based on the processed audio input. In an embodiment, once the siren sound is isolated from the noise, sound detection module 400 will analyze the characteristics of that siren sound to determine a match with an acoustic pattern, for example of an ambulance, a police vehicle, a crash sound, etc., thereby identifying the type of vehicle for further identifying the target vehicle which is the source of the external sound.

Sound detection module 400 may extract relevant audio features from the filtered sound signals. Sound detection module 400 processes the filtered audio data and prepares it for analysis by a machine learning module. The extracted features may comprise one or more characteristics such as frequency components, duration, and intensity of the sound, which provide more information for identification of the external sound. In an embodiment, it could extract features that distinguish the oscillating pitch of an ambulance siren from the non-oscillating sound of a construction vehicle.

Microphone or an audio sensor: As mentioned herein, sound identification systems may use sound pattern recognition to capture and identify external sounds by comparing them to the database of pre-existing audio patterns. Sound is captured by a microphone or an audio sensor and converted into digital signals, typically represented in the form of waveforms. The model then processes these waveforms through feature extraction, breaking down the sound into distinctive elements like frequency (pitch), amplitude (loudness), duration, and rhythm. In addition, advanced features such as Mel-frequency cepstral coefficients (MFCCs), which represent the power spectrum of sound, and spectrograms, which visualize sound frequencies over time, may be used to represent sounds that machines can analyze easily. Once the sound is represented through these features, machine learning models, particularly deep learning models such as convolutional neural networks (CNNs) and recurrent neural networks (RNNs) may be used. CNNs may be used because they are effective at processing images, making them suitable for spectrogram analysis, where sound data is treated as an image. RNNs, on the other hand, may be effective for sequential data and can capture temporal patterns in sounds, which may be used for identifying sounds that have characteristic time-based variations, such as alarms or sirens.

For training the AI models for sound recognition, the models are exposed to large datasets of labeled sounds to learn the distinctive characteristics of each category. In an embodiment, a dataset may comprise one or more examples of sirens, alarms, crash sounds, etc., and in different noisy environments, at different distances, angles, etc. In an embodiment, temporal data or continuous time data may be used to train and analyze for approaching/converging sound recognition or moving away/diverging sound recognition. The model uses this data to learn patterns and generalize them, allowing it to identify these sounds in real-world scenarios. Additionally, sound pattern recognition models may incorporate noise reduction techniques and filters to isolate the relevant sound features, improving recognition accuracy in noisy environments.

After training, these models would be deployed in real-time applications, where they compare incoming sound patterns with stored representations in real-time. When a match or high probability of similarity is identified, the model labels the sound accordingly. The models may be updated periodically with new sounds and/or sounds with various environmental noises, allowing them to adapt to changing environments and recognize emerging sound patterns.

When a sound, such as an ambulance siren or alarm beep, is captured by the microphone or the audio sensor of the vehicle, it is converted into a digital signal and provided as an input to the trained models. This signal is then analyzed to extract key characteristics, including frequency, amplitude, pitch, and temporal patterns. Sound recognition algorithms, often supported by machine learning models, compare these characteristics against a library of known sound signatures. The identification process comprises classifying the sound into distinct features, such as spectral peaks and harmonic structures, which are unique to specific types of sounds. In an embodiment, sirens and alarms have repetitive, oscillating patterns in both frequency and amplitude that differentiate them from other sounds. The system then applies a matching algorithm to compare these extracted features with the stored reference sounds/predetermined set of sounds in the database. If a close match is found, the system recognizes the sound and categorizes it accordingly. If a match or close similarity is found, sound detection module 400 identifies the sound and assigns it a label, such as “ambulance siren”, “police siren,” etc. In an embodiment, the system may use neural networks/machine learning algorithms trained on vast datasets of labeled sounds, enabling identification even in noisy environments.

Acoustic sensor: The acoustic sensor monitors external sounds, such as sirens or horns, by capturing them as analog signals. The signal is digitized and processed to detect whether it matches any sounds from a predetermined set, such as emergency sirens. Once a sound is captured, the system compares it with a database of known sound profiles to identify both the sound type (e.g., ambulance siren) and a source (e.g., target vehicle). By analyzing the intensity and directional properties of the sound waves, the system calculates the direction from which the sound originated. This enables the system to determine the relative position and distance of the target vehicle in relation to the host vehicle.

Ultrasonic sensors: Ultrasonic sensors emit sound waves and detect reflected waves from nearby objects, monitoring for any vehicle or obstacle that may indicate proximity to a target vehicle. Based on the reflected signals, the system differentiates between stationary objects and moving vehicles by analyzing frequency shifts. If a reflection matches the signature of a moving vehicle, the system recognizes it as a target vehicle. The time delay between emitted and received waves allows the system to calculate the exact distance and direction of the target. This data is used to generate an alert signal to the driver of the host vehicle.

Vibration Sensors: Vibration sensors detect oscillations that might suggest the movement of nearby vehicles, such as heavy vehicles or emergency responders. The system processes these vibrations to determine if they match the patterns caused by specific types of vehicles. In an embodiment, a high-frequency vibration pattern may correspond to an emergency vehicle. By analyzing the intensity and frequency of the vibrations, the system can identify the direction and distance of the external sound.

Pressure Sensors: Pressure sensors detect changes in the surrounding air pressure, which may signal the presence of large or fast-moving vehicles. The system analyzes pressure fluctuations to determine if they correlate with typical pressure profiles of a nearby large or emergency vehicle, identifying such a vehicle as a potential target vehicle. By measuring the magnitude and direction of pressure changes, the system estimates the location of the target vehicle relative to the host vehicle. The driver receives an alert if the identified vehicle is within a certain range or approaching rapidly.

Radar Sensors: Radar sensor is a device that uses radio waves to detect and measure the distance, velocity, and angle of target vehicles in its surroundings. The radar sensor comprises a transmitter that emits radio waves as continuous or pulsed signals. These waves propagate through the environment and reflect off any detected target vehicles. The receiver captures these reflected signals, analyzing the time delay, frequency shift, and phase. This data enables the sensor to calculate the target vehicle's distance, speed, and angle relative to the host vehicle.

To determine the distance to the target vehicle, the radar sensor measures the round-trip time of the signal (the time it takes for the radio wave to travel to the target vehicle and back). Knowing the speed of radio waves (the speed of light), the radar calculates the exact distance to the target vehicle.

The radar sensor may use Doppler effect to determine the relative velocity of a target vehicle. If the target vehicle is moving toward the host vehicle, the reflected wave's frequency increases; if the target vehicle is moving away, the reflected wave's frequency decreases. By measuring this frequency shift, the radar sensor can calculate the speed and direction at which the target vehicle is moving.

In an embodiment, the radar sensor is equipped with an array of multiple antennas. By analyzing the phase difference of the reflected signals received by each antenna, the radar can calculate the Angle of Arrival (AoA). This gives the radar sensor an estimate of the direction of the target vehicle, whether it is in front, behind, or to which side of the host vehicle.

In an embodiment, the area around the host vehicle is divided into four quadrants (front left, front right, rear left, and rear right) to monitor target vehicles. By combining distance, AoA, and Doppler data, the system determines the specific quadrant in which the target vehicle is located. This enables the system to track the target vehicle's movement over time, predict its future position, and assess potential risks.

LiDAR Sensors: LiDAR sensors emit laser pulses to detect the surroundings and monitor for approaching vehicles or obstacles, particularly in low-light or foggy conditions. By analyzing the 3D shapes and spatial data, the system identifies the type of object (e.g., vehicle) and distinguishes between stationary and moving targets, labeling relevant targets based on stored shape profiles. LiDAR provides precise 3D mapping data, allowing the system to calculate both the direction and exact location of the target vehicle with respect to the host. An alert signal is displayed with directional guidance to inform the driver.

In an embodiment, one or more cameras are mounted on the host vehicle to continuously capture images or video of the surroundings comprising other vehicles, pedestrians, road signs, and infrastructure. Once captured, the raw visual data is preprocessed to improve quality enhancing clarity by reducing noise, adjusting lighting, and stabilizing frames. This preprocessing step ensures that the images are clear and ready for analysis, allowing the system to detect and identify objects.

Using machine learning models, such as convolutional neural networks (CNNs), the system analyzes the images to detect the target vehicle. These models have been trained on large datasets to recognize different classes such as emergency vehicles, traffic signs, and pedestrians. In an embodiment, the system can identify emergency vehicles by recognizing visual markers, such as flashing lights and specific colors, and then classify these objects accordingly. When combined with audio sensors, the system can correlate sounds (such as sirens) with the detected vehicles, refining its identification by matching visual and audio cues to identify the target vehicle.

After identifying relevant objects, the system uses techniques such as stereo vision (if multiple cameras are used) or monocular depth estimation to determine the distance and angle of these objects relative to the host vehicle. By assessing the scale, size, and orientation of approaching objects, the system can estimate their precise locations. To enhance safety, the system continuously tracks the position and movement of the target vehicle, enabling the target vehicle's likely path to be predicted based on its speed and trajectory. In an embodiment, if an emergency vehicle is detected approaching from behind, the display would show its direction and distance, helping the driver react promptly. Based on these insights, the system can also generate alerts such as visual cues on the display and audio alerts to ensure the driver's attention is directed to any potential hazard.

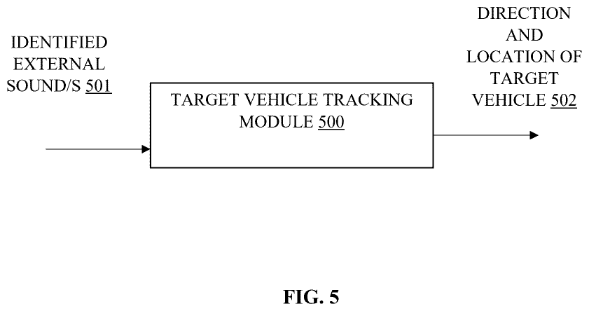

FIG. 5 illustrates a block diagram of target vehicle tracking module 500 according to one or more embodiments. Target vehicle tracking module 500 processes the identified external sound 501 from sound detection module (shown in FIG. 4) to determine an angle at which the external sound is originating, thereby identifying a direction and a location of the target vehicle 502 (i.e., direction of the external sound) in relation to the host vehicle and thus enabling tracking of the target vehicle. In an embodiment, if a siren is detected from the front and left side of the host vehicle, target vehicle tracking module 500 will output directional data indicating that the target vehicle is present in the front left quadrant. In an embodiment, the direction of the external sound may be represented in degrees measured in either clockwise or counterclockwise direction from a reference line. The direction may be represented as an angle, by quadrant, or by sector as it may be appropriate. In an embodiment, when the origin of the external sound is very far and the direction is not very clear, then it may be represented by quadrant, and when the direction of origin of the external sound is identified, it may be precisely represented by angle relative to the host vehicle.

In parallel, target vehicle tracking module 500 determines the distance of the target vehicle from the host vehicle. Target vehicle tracking module 500 uses data from the sensors and the characteristics of the identified external sounds to estimate how far away the target vehicle is from the host vehicle. In an embodiment, target vehicle tracking module 500 may determine that the target vehicle, such as an ambulance, is 150 meters away based on the intensity and frequency of the sound detected.

In an embodiment, target vehicle tracking module 500 is configured for determining the location and direction of a source of the external sound by analyzing key sound characteristics, including time differences of arrival (TDOA), frequency-dependent properties, intensity variations, and phase differentials to achieve spatial sound localization. The system comprises an array of microphones strategically positioned at fixed, known locations to capture sound waves from the environment. By calculating the TDOA for sound signals reaching each microphone, the system determines relative timing differences between microphones. These differences provide angular positioning data, enabling the system to estimate the direction of the sound source through triangulation or beamforming processes.

The system further utilizes frequency-specific properties to enhance localization accuracy. Higher-frequency sounds, which exhibit increased directional sensitivity due to natural shadowing effects, yield sharper directional cues and allow the system to prioritize high-frequency components when available for more precise localization. Intensity or amplitude variations, similar to interaural level differences observed in human auditory processing, are also assessed. The system analyzes these intensity discrepancies between microphones, with greater amplitude detected in microphones closer to the source, thereby refining directional accuracy.

In addition, the system leverages phase differences, particularly valuable for continuous tones or complex sound waves, to differentiate multiple simultaneous sources. By applying Fourier transform or other spectral analysis techniques, the system decomposes complex sounds into frequency components, enabling the separation and precise localization of multiple sources in real-time. The system further may comprise algorithms to process sound attenuation and reverberation data, providing cues to estimate the distance of the sound source by accounting for sound energy loss over distance and reflective characteristics in the environment.

This integrated approach, which iteratively combines TDOA, frequency prioritization, intensity differences, and phase analysis, allows the system to generate a comprehensive spatial representation of the sound environment. The system achieves high localization accuracy, even in complex, multi-source conditions, by continuously refining the spatial model based on real-time sound data.

To continuously track an identified sound source over time and determine whether it is approaching, diverging, or changing position, the system may use Doppler shift analysis in conjunction with signal strength monitoring and directional audio sensing. The process involves capturing the sound signal continuously, analyzing changes in one or more of its frequency, amplitude, and spatial direction over time to infer the movement of the sound source.

Using Doppler shift analysis, the system can continuously monitor frequency shifts in the sound signal and interpret them to determine the source's movement direction. An increasing frequency indicates that the source is approaching, while a decreasing frequency suggests it is moving away.

Tracking the amplitude or signal strength over time provides additional information about the source's proximity. As a sound source gets closer, the amplitude (loudness) of the signal generally increases due to less distance and reduced signal attenuation. Conversely, as it moves farther away, the amplitude decreases. This approach complements Doppler analysis by verifying changes in distance.

By using an array of microphones (or microphone equivalents), for directional audio sensing, which are arranged in a specific pattern, the system can detect the direction from which the sound originates and monitor any change in this direction over time. Triangulation, or beamforming, can pinpoint the sound's origin, tracking its lateral movements and changes in spatial positioning.

With continuous analysis, target vehicle tracking module 500 can map the sound source's path and movement pattern thus mapping the target vehicle's path.

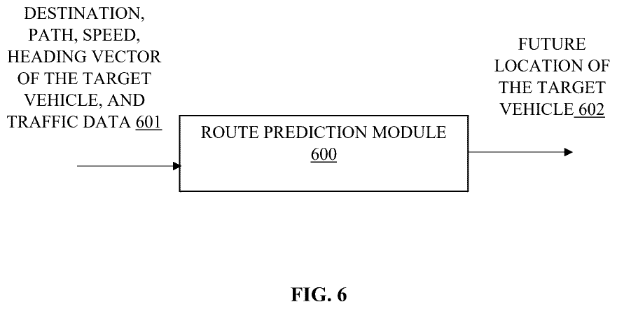

FIG. 6 illustrates a block diagram of route prediction module 600 according to one or more embodiments. Route prediction module 600 predicts a future location of the target vehicle 602. By continuously analyzing a destination of the target vehicle, a path of the target vehicle, a current speed of the target vehicle, a current heading vector of the target vehicle, and current traffic data 601, route prediction module 600 determines the future location of the target vehicle 602.

The system may utilize real-time traffic data, including road layout, traffic flow, and traffic light patterns, which may be obtained from publicly available databases or via various Applications such as Google Maps®. Real-time traffic data, including road layout, traffic flow, and traffic light patterns, along with the analysis of the sound, allows the system to predict the path of the target vehicle. In an embodiment, if traffic data indicates congestion on one route, then the target vehicle (e.g., ambulance) may be predicted to take an alternate, clearer path.

In an embodiment, route prediction module 600 may use Kalman filtering, a mathematical algorithm that combines sensor data (such as speed, direction, and location) and predicts the future location of the target vehicle 602 based on its current location.

Route prediction module 600 uses Kalman filtering to predict the future location of the target vehicle 602 by continuously estimating its dynamic state, such as position, speed, and direction, even in the presence of sensor noise or varying environmental conditions. This process starts with initializing an estimated state of the target vehicle based on its current position, speed, and heading vector. At this stage, Kalman filter may assign uncertainty values to account for potential measurement errors, establishing a baseline state that will serve as a reference for future updates.

In the prediction phase, route prediction module 600 applies a motion model that predicts the target vehicle's next state using its current speed, direction, and any established movement patterns. In an embodiment, if the target vehicle is moving in a straight line, the filter will predict its continued forward motion; if the target vehicle is turning, the filter can adjust the prediction to accommodate this path. In an embodiment, this predicted state is only an initial estimate and serves as a preparatory step for incorporating new data as it becomes available.

As the target vehicle progresses, route prediction module 600 receives real-time data inputs, such as live traffic information from applications such as Google Maps®. This traffic data provides information on road layouts, current traffic congestion, and even traffic light patterns, which may influence the vehicle's likely route choices. In an embodiment, if traffic data shows congestion on the direct route, the Kalman filter might predict that the target vehicle, especially if it's an emergency vehicle, will choose an alternate, less congested path.

The Kalman filter may enter the update phase, where it incorporates the real-time data from sensors such as updated positions, speeds, or heading data to adjust its previously predicted state. During this phase, Kalman filter combines the predicted state with the actual observed state, balancing them based on the uncertainty associated with each. This enables the module to refine its current understanding of the target vehicle's location, speed, and trajectory by incorporating both recent predictions and new real-time observations.

Kalman filter may minimize prediction errors by continuously adjusting its calculations based on real-time feedback. By accounting for inevitable noise in sensor data (like minor inaccuracies in GPS location), the filter refines each prediction cycle, resulting in increasingly accurate estimates of the target vehicle's likely future position. This continuous prediction and update cycle enables the module to generate a real-time forecast of the target vehicle's movements, even dynamic changes in traffic conditions, helping the host vehicle adjust its own route or speed accordingly.

In an embodiment, route prediction module 600 may use machine learning-based predictive modeling. By training models on large datasets that comprise historical vehicle movement patterns and environmental factors, the system can recognize recurring behaviors and predict the future movements of the target vehicle. In an embodiment, supervised learning techniques, such as regression models or neural networks, are used to correlate past data with expected future actions, helping the system understand patterns like acceleration, deceleration, or turns based on the target's previous trajectory.

In an embodiment, route prediction module 600 may employ trajectory prediction algorithms to estimate the target vehicle's future path. These algorithms analyze the current motion of the target and apply physical laws of motion, including acceleration and deceleration rates, to determine the future locations of the target vehicle.

In an embodiment, route prediction module 600 may use communication between the host vehicle and the target vehicle to predict future locations. Through vehicle-to-vehicle (V2V) communication, the target vehicle may share its planned route, speed, and heading information directly with the host vehicle. This communication enables route prediction module 600 to determine the future location of the target vehicle 602 based on real-time updates. In an embodiment, an ambulance could communicate its destination and route directly, allowing the host vehicle to adjust its lane and speed proactively, ensuring safe and efficient movement in response to the emergency vehicle.

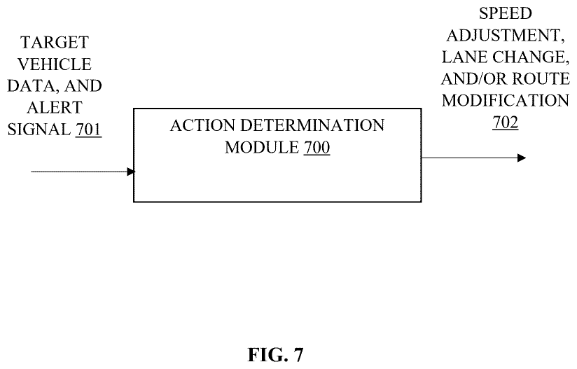

FIG. 7 illustrates a block diagram of action determination module 700 according to one or more embodiments. Action determination module 700 determines an action for the host vehicle upon detecting the future location of the target vehicle by route prediction module 600 (as depicted in FIG. 6). Action determination module 700 may take target vehicle data (destination, path, speed, heading vector, future location of the target vehicle, and traffic data,), and alert signal 701 as an input. Action determination module 700 determines the action such as a first change in speed of the host vehicle, a second change of a lane of the host vehicle and change a route of the host vehicle 702. In an embodiment, the first change in the speed of the host vehicle comprises one of reducing the speed and increasing the speed and the second change in the lane comprises moving from a current lane to another lane. Action determination module 700 prioritizes actions based on an urgency determined based on a characteristic of the external sound. The characteristic may comprise one or more of a pattern, a frequency modulation, a volume intensity, and type of the target vehicle. Action determination module 700 may use techniques such as sound frequency analysis and machine learning to determine urgency based on sound characteristics such as intensity, frequency patterns, and modulation. In an embodiment, sounds with a high oscillation frequency and high intensity may be prioritized, as they could indicate an emergency vehicle nearby.

In an embodiment, action determination module 700 uses predefined rules to determine the action based on the external sound. In an embodiment, if an emergency vehicle siren is detected nearby, a rule might indicate that the action determination module 700 recommends slowing down or moving to an adjacent lane if one is available.

Example: In heavy traffic, if the system detects an emergency vehicle approaching from behind, action determination module 700 determines the action as switching lanes if the right lane is open, allowing the emergency vehicle to pass.

In an embodiment, action determination module 700 uses machine learning classification that uses machine learning models trained on historical data to prioritize the action based on the urgency determined based on the characteristic of the external sound. The machine learning models are trained to recognize specific sound characteristics (e.g., frequency, amplitude, or modulation patterns) and match these with labeled scenarios such as emergency vehicle proximity or road obstruction, allowing the action determination module 700 to suggest appropriate actions.

Example: If the system identifies the sound as belonging to an ambulance, the module analyzes factors such as urgency (determined by the increasing volume of the siren and speed of approach). Action determination module 700 generates actions, such as reducing speed and suggesting a lane change if it is safe and feasible.

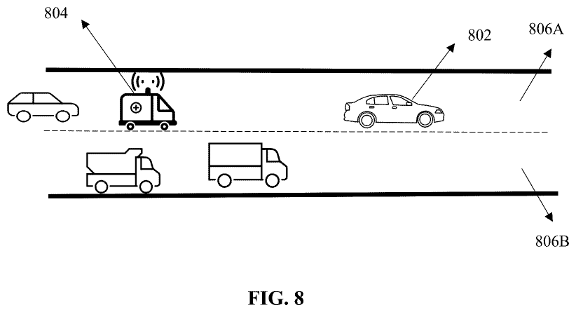

FIG. 8 illustrates an interaction between a host vehicle 802 and a target vehicle 804 according to one or more embodiments. In an embodiment, a system is integrated within the host vehicle 802. In an embodiment, a system is integrated in a server. In an embodiment, the target vehicle 804 is positioned in the same lane as the host vehicle 802, specifically in lane 806A, while an adjacent lane is labeled as 806B.

System detects the external sound of the target vehicle 804, e.g., ambulance's siren, using sensors. By identifying the external sound and the target vehicle 804 corresponding to the external sound, the system determines the direction and the location of the target vehicle with respect to the host vehicle, based on the external sound. Based on this information, the system alerts the driver to the presence of the target vehicle 804.

The system then generates an action for the host vehicle 802. In an embodiment, this action comprises a speed adjustment. In an embodiment, if the ambulance is rapidly approaching from behind, the system alerts the host vehicle 802 to decelerate the speed, allowing the target vehicle 804 to pass safely. Alternatively, if the ambulance is nearby and moving in the same direction, the system may increase the host vehicle's speed slightly to clear the lane. In another embodiment, the system may initiate a lane change. In an embodiment, if the host vehicle 802 is in lane 806A, the system may recommend a shift to lane 806B to provide a clear path for the target vehicle 804. After the ambulance passes, the system may prompt the host vehicle 802 to safely return to its original lane if traffic conditions permit.

In an embodiment, the system may recommend a route change. If the target vehicle 804 is expected to remain on the host vehicle's route for an extended distance, the system can suggest an alternative route to minimize delays and maintain safety. In cases of heavy traffic, the host vehicle 802 may be directed onto a side road to allow the ambulance to proceed, after which the host vehicle can return to its original route.

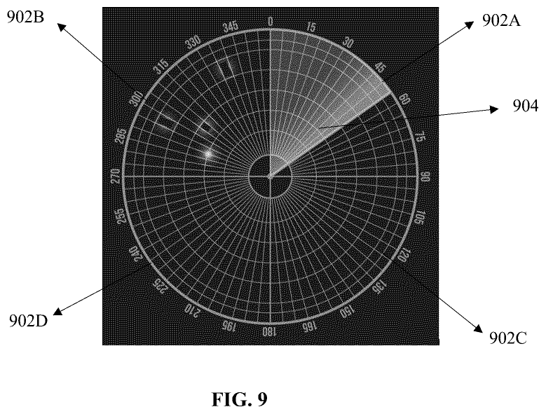

FIG. 9 illustrates an exemplary diagram to detect a target vehicle 904 using a radar chart with four quadrants according to one or more embodiments. The radar divides the space around the host vehicle into four quadrants: Front Right Quadrant (FRQ) 902A, Front Left Quadrant (FLQ) 902B, Rear Right Quadrant (RRQ) 902C and Rear Left Quadrant (RLQ) 902D corresponding to the location of the target vehicle 904 relative to the host vehicle. The radar sensor, positioned at the center of this map, identifies and tracks objects or target vehicles in each quadrant, providing a picture of their relative positions and movements.

Front Right Quadrant (FRQ) 902A: This section of the display covers the front right area of the host vehicle. When the target vehicle is detected in this area, the dashboard will display an indicator in the FRQ to notify the driver.

Front Left Quadrant (FLQ) 902B: This quadrant represents the area in front and to the left of the host vehicle. If the system detects the target vehicle approaching from this area, a visual cue is activated in the FLQ to alert the driver.

Rear Right Quadrant (RRQ) 902C: This quadrant signifies the area behind and to the right of the host vehicle. If the system detects the target vehicle in this area, a corresponding indicator appears on the display, providing the driver with visual information about the target vehicle's location.

Rear Left Quadrant (RLQ) 902D: The RLQ represents the space behind and to the left of the host vehicle. If the system identifies the target vehicle approaching from this quadrant, a visual cue is activated, alerting the driver of its presence in the RLQ.

The radar map comprises concentric range circles around the host vehicle to indicate various distance thresholds. In an embodiment, the first circle may represent a distance of 100 meters, marking objects within close range. The second circle could indicate 200 meters, and additional circles might represent 300 meters or beyond, extending the radar's range to detect vehicles or obstacles at various distances. These distance markers enable visual quantification of how far each detected vehicle or object is from the host vehicle.

The radar sensor transmits radio waves that bounce off objects, such as the target vehicle 904, and return to the radar receiver in the host vehicle. Using an array of antennas, the radar sensor can measure the difference in time it takes for the reflected signal to reach each antenna. This time difference, or phase shift, allows the system to calculate the angle at which the reflected signal arrives. In an embodiment, if the radar detects the target vehicle 904 in the front right quadrant 902A, it calculates the AoA, which might indicate an angle of, say, 45° relative to the host vehicle's heading (straight-ahead direction). The radar sensor also measures the Doppler shift in the frequency of the returned signal. This frequency shift is caused by the relative movement between the host vehicle and the target vehicle 904, allowing the system to calculate the target's speed and direction (toward or away from the host vehicle). By combining the Doppler shift data with the AoA, the radar can identify whether the target vehicle 904 is approaching, moving away, or moving laterally relative to the host vehicle. The radar measures the time it takes for the signal to travel to the target and back to calculate the distance to the target vehicle 904. This provides range information, which, along with the AoA, allows the system to position the target in a specific quadrant and at a specific angle and distance. With the angle and distance calculated, the system identifies the quadrant where the target vehicle is located and maps it onto the radar chart. In this example, the target vehicle 904 is detected in the front right quadrant 902A at around 500 meters away at a 45° angle. As the target vehicle 904 moves, continuous AoA and Doppler measurements allow the radar sensor to track its changing angle, direction, and speed, enabling real-time monitoring.

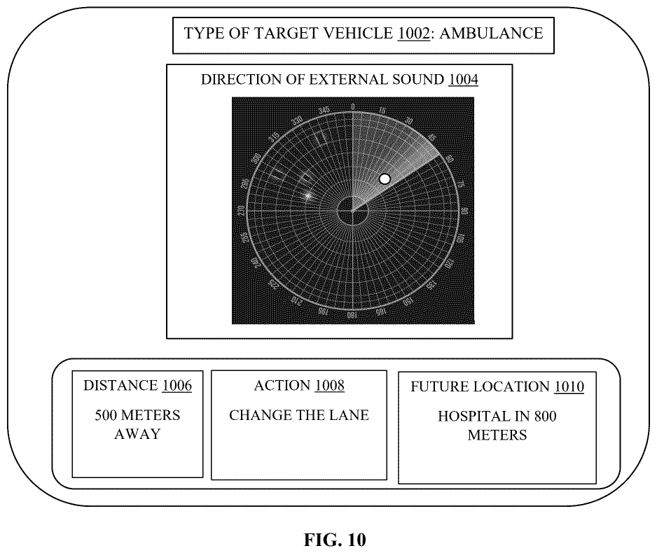

FIG. 10 illustrates a vehicle dashboard display that provides real-time data about an approaching emergency vehicle according to one or more embodiments. The user interface displays information comprising the type of the target vehicle 1002 as an ambulance, enabling the driver to quickly recognize the situation. The dashboard also shows the direction of the external sound 1004 in a radar map which may be represented as an angle.

In this example, a visual cue on the dashboard indicates that the ambulance is approaching from the Front Right Quadrant (FRQ), which is indicated as a circle to provide a clear spatial reference of the ambulance's position relative to the host vehicle. The system also displays the distance 1006 between the host vehicle and the target vehicle, showing that the ambulance is 500 meters away, allowing the driver sufficient time to react. Based on the target vehicle's position and distance, the system generates an action 1008. This action may comprise suggestions such as reducing the host vehicle's speed or changing lanes. In this example, the system recommends a speed reduction, which is indicated by a visual cue on the dashboard. Additionally, the display may comprise information regarding the ambulance's future location 1010, allowing the driver to anticipate the target vehicle's path and take appropriate action.

FIG. 11 illustrates communicating information from the target vehicle to the host vehicle according to one or more embodiments. In FIG. 11, the future location of the target vehicle is predicted based on vehicle-to-vehicle (V2V) communication between the host and target vehicles. This communication enables the host vehicle to receive real-time data directly from the target vehicle, which can enhance the accuracy of the prediction and improve decision making. The target vehicle may communicate its current speed, which enables the host vehicle to assess whether the target is approaching, moving away, or maintaining a steady position relative to itself. The target vehicle may communicate destination coordinates to the host vehicle. Additionally, the target vehicle may communicate path vector data comprising the projected trajectory and any upcoming maneuvers, such as lane transitions, turns, or highway exits, which support the host vehicle in anticipating spatial changes in traffic.

The target vehicle may communicate the heading vector, or the direction in which the target vehicle is traveling, allowing the host to align its trajectory with the anticipated movement of the target vehicle, minimizing risks of overlap or collision. In an embodiment, the target vehicle may also transmit traffic and environmental data comprising information about upcoming hazards, congested zones, or changing weather conditions.

Additionally, the target vehicle may communicate acceleration or deceleration rate to provide insight into any sudden changes in speed. In an embodiment, if the target vehicle is accelerating quickly, the host vehicle might prioritize a lane change to avoid potential conflicts. In an embodiment, the target vehicle may communicate the location and position of the target vehicle as GPS coordinates or lane-specific data. This location data, combined with the planned path or route of the target vehicle, such as highway exits or upcoming turns, gives the host vehicle a clearer understanding of where the target vehicle is likely to be in the near future. Further, the target vehicle may communicate its intention to change lanes. In an embodiment, the target vehicle plans to move into an adjacent lane where the host vehicle is currently traveling or planning to move. This intention signal allows the host vehicle to adjust its lane choice or speed to prevent any interference. In an embodiment, the target vehicle may communicate real-time data about the brake status of the target vehicle, indicating whether it is braking or preparing to slow down.

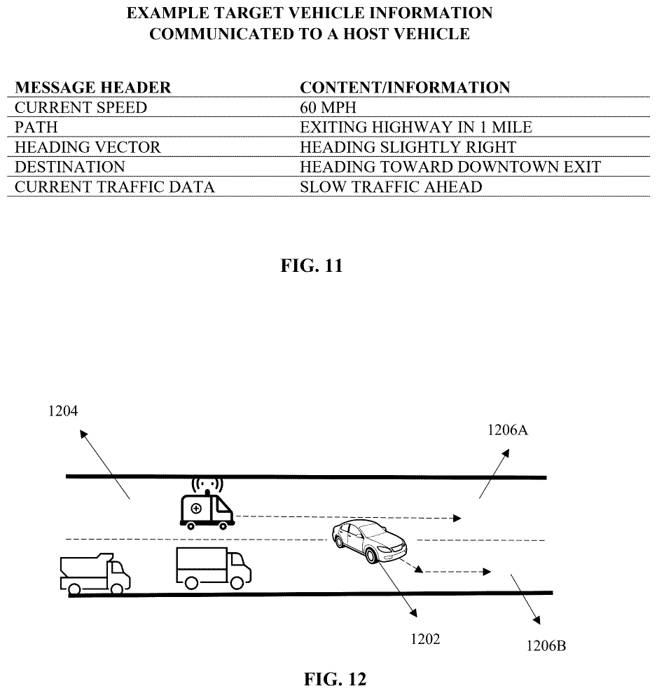

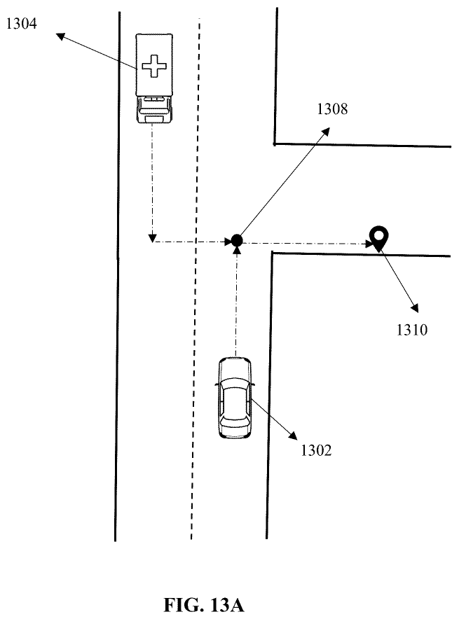

FIG. 12 illustrates generating an action to change the lane of the host vehicle 1202 according to one or more embodiments. In an embodiment, the host vehicle 1202 transits from lane 1206A to lane 1206B, based on real-time traffic conditions and the predicted future location of the target vehicle 1204. The system recommends a lane change to provide a clear passage for the target vehicle 1204, ensuring the host vehicle 1202 avoids potential conflicts.

In an embodiment, the system predicts the future location of the target vehicle 1204, based on a destination of the target vehicle 1204, current speed of the target vehicle 1204, heading vector of the target vehicle 1204, path of the target vehicle 1204, and traffic data. If the system determines that the target vehicle 1204 will remain in its current lane and the host vehicle 1202 will soon encounter a significant speed difference or potential obstacle, it may suggest a lane change rather than reducing speed or altering the host vehicle's route.

In an embodiment, if the target vehicle 1204 is moving at a slower speed in lane 1206A and the host vehicle 1202 is approaching quickly, reducing speed might not be enough to avoid disruption in traffic or a potential collision, especially if vehicles behind the host vehicle are traveling at high speeds. Altering the host vehicle's route, such as exiting the highway, might be difficult in this situation. In contrast, changing to lane 1206B provides a more efficient solution, allowing the host vehicle 1202 to bypass the slower target vehicle without affecting traffic flow or requiring speed adjustments.

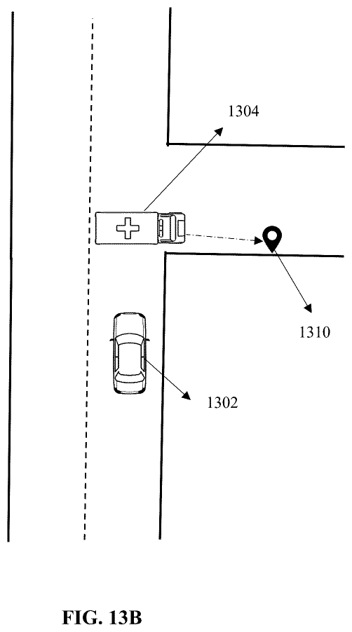

FIGS. 13A-13B illustrate predicting a path of the target vehicle and an interaction location on the path where an interaction of the host vehicle and the target vehicle occurs according to one or more embodiments. In an embodiment, the system is integrated within the host vehicle 1302. In an embodiment, the system is integrated into the server. In this embodiment, system monitors, using the sensors, for an external sound matching with at least one from a predetermined set of sounds, configured to generate an alert signal to a driver of a host vehicle 1302. The system identifies the external sound and a target vehicle 1304 corresponding to the external sound. The system determines continuously, using the sensors, a direction and a location of the target vehicle 1304 with respect to the host vehicle 1302, based on the external sound and updates of the direction and the location of the target vehicle 1304. Once the direction and location are identified, the system uses this information to predict a path for the target vehicle. This prediction is based on one or more of a destination of the target vehicle, a current speed of the target vehicle, a current heading vector of the target vehicle, and a current traffic data. The system identifies an interaction location on the path where an interaction between the host vehicle and the target vehicle occurs based on a current path of the host vehicle. The system predicts interaction location based on the path of the target vehicle, a current speed of the target vehicle, a current heading vector of the target vehicle, a current speed of the host vehicle, a heading vector of the host vehicle, a path of the host vehicle, and a current traffic data. The system provides, automatically, a resistance to a movement of the host vehicle 1302 to be on the path in a range near to the interaction location 1308. The system further determines time points for the interaction location.

In an embodiment, the resistance to the movement of the host vehicle is provided by automatically performing steering corrections. Steering corrections involve integration between the steering actuators and an electronic control unit (ECU) of the host vehicle 1302. This system relies on the Electronic Power Steering (EPS) system, where an electric motor assists in steering. When the interaction location of the target vehicle is detected, the ECU, which continuously monitors inputs from sensors, determines the steering angle adjustment required to keep the host vehicle in a current lane. The EPS system receives control signals that modulate the electric motor torque applied to the steering column, adjusting the steering angle incrementally without requiring driver intervention. The calculations for these corrections are based on real-time data from sensors, including lateral position, yaw rate, and steering angle sensor data.

In an embodiment, the resistance to the movement of the host vehicle is provided by providing torque feedback on a steering wheel of the host vehicle making the steering wheel physically harder for the driver to turn. Torque feedback is implemented via a torque control module in the EPS. This module uses input from torque sensors, which measure the amount of force applied by the driver and any feedback forces required by the system. In scenarios where the host vehicle approaches an interaction location, the EPS control unit commands the motor within the EPS system to generate resistance torque on the steering wheel. This additional torque is achieved by increasing the electrical current to the motor, effectively creating a counterforce. The system calculates the necessary resistance based on parameters such as the current vehicle speed, time points for the interaction location, etc. The steering column comprises torque sensors and a brushless motor that can apply controlled resistance, allowing the system to vary torque output dynamically. This method ensures that the feedback force is proportional to the vehicle's proximity to the interaction location and provides tactile feedback, alerting the driver to stay within safe bounds.

In an embodiment, the resistance to the movement of the host vehicle is provided by employing selective braking on a side to create a pulling force to keep the host vehicle in a current lane. Selective braking involves the use of individual wheel brakes to produce a yaw moment that influences the host vehicle's lateral position without altering the steering angle. This process is controlled by the vehicle's stability control module, which coordinates with the braking system to apply asymmetric braking force to the wheels. When selective braking is activated, the module instructs the hydraulic control unit to deliver braking pressure to specific wheels (usually on the opposite side of the anticipated interaction location) to create a pulling force.

This braking force is calculated based on the vehicle's speed, weight distribution, and lateral acceleration. The control unit processes sensor data from the yaw rate sensor, wheel speed sensors, and accelerometers. By delivering braking pressure to a specific wheel, the system keeps the host vehicle in a current lane.

In FIG. 13A, the system is illustrated with the host vehicle 1302 traveling straight on a road near a target vehicle 1304 which is represented as an emergency vehicle, travelling in the opposite direction of the host vehicle. In this scenario, the system detects the sound of the emergency vehicle's siren through the sensors. After processing the sound, the system determines the direction and location of the target vehicle 1304, identifying that the emergency vehicle is approaching from the front left quadrant, while the destination of the target vehicle 1310 is to the right of the host vehicle 1302.

Based on this information, the system analyzes the speed and heading vectors of both the host vehicle 1302 and the target vehicle 1304, predicting an interaction location ahead where their paths may intersect. The system alerts the driver of the host vehicle 1302 to the presence of the emergency vehicle by displaying this information on the dashboard screen. Additionally, the system suggests actions, such as reducing speed, to allow the emergency vehicle to turn left and pass safely in front of the host vehicle.

In FIG. 13B, upon determining the interaction location, the system automatically provides a resistance to a movement of the host vehicle to be on the path in a range near to the interaction location. Simultaneously, the system may apply steering resistance to help maintain the host vehicle 1302 in its current lane, preventing sudden or unintentional movements toward the predicted interaction point. This resistance is implemented by adding torque feedback to the steering wheel, making it more difficult for the driver to turn the wheel toward the left lane, thus helping to keep the host vehicle in its current lane until the emergency vehicle has safely passed the interaction location. In an embodiment, if the driver of the host vehicle 1302 attempts to change lanes leftward towards the predicted interaction location, the system would apply additional torque on the steering wheel to maintain the host vehicle in its current lane, thereby preventing sudden lane shifts.

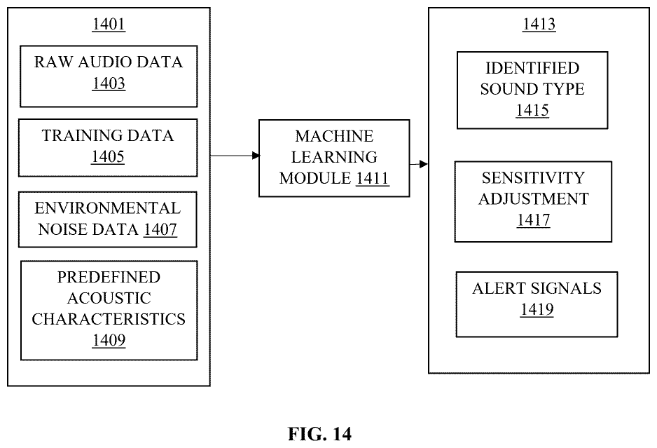

FIG. 14 shows an example block diagram for a machine learning module according to one or more embodiments. In FIG. 14, the machine learning module 1411 receives inputs 1401 such as raw audio data 1403, training data 1405, environmental noise data 1407, and predefined acoustic characteristics 1409. The machine learning module 1411 generates outputs 1413, including identified sound type 1415, sensitivity adjustment 1417, and alert signals 1419. The raw audio data 1403 comprises unprocessed audio signals captured by the sensors, the training data 1405 comprises a collection of previously recorded sounds from emergency vehicles that serve as a reference for training the system, the environmental noise data 1407 comprises contextual information about ambient noise levels to minimize false positives, and the predefined acoustic characteristics 1409 comprises expected sound profiles of specific emergency vehicles.

The outputs 1413 generated by the machine learning module 1411 comprise identified sound type 1415 representing the classification of detected sounds; the sensitivity adjustment 1417 comprises modifications to detection sensitivity according to environmental conditions; and the alert signals 1419 comprise notifications generated by the machine learning module 1411 to inform the driver of identified emergency vehicles. Through these inputs and outputs, the machine learning module 1411 enhances the system's capability to identify and respond to external sounds in real-time.

Business problem: In today's traffic environments, drivers face significant challenges in reacting to external sounds such as emergency vehicle sirens or crash noises. The inability to quickly and accurately determine the direction and location of these sounds can lead to delayed responses, unsafe driving decisions, and increased risk of accidents. This not only endangers the driver but also creates liability concerns for vehicle manufacturers and operators. Existing vehicle systems lack the ability to assist drivers in identifying and responding to external auditory cues, leading to potential safety and legal repercussions, particularly in high-traffic or emergency scenarios.

Business solution: The business solution improves road safety and reduces liability risks by providing a sound detection and tracking solution integrated into vehicles. Utilizing the sensors, the system continuously monitors for external sounds, such as emergency vehicle sirens, and identifies the direction, location, and movement of the sound source. By displaying this information on the vehicle's interface, the system allows drivers to make timely, informed decisions, avoiding potential hazards. Additionally, the system predicts future movements and the interaction location where the host and target vehicle paths may intersect. In these high-risk zones, the system automatically provides resistance to the host vehicle's movement, helping the driver avoid potential hazards. This system enhances driver response time for emergency vehicles and increases traffic awareness, effectively reducing the risk of collisions.

Technical problem: Drivers often struggle to accurately determine the direction and location of external sounds, such as sirens from emergency vehicles or other critical noises, while navigating through traffic. The current in-vehicle systems do not provide adequate assistance in identifying the source of these sounds in real-time. As a result, drivers may experience delays or make incorrect decisions, such as moving toward an emergency vehicle instead of away from it, obstructing the path of the emergency vehicles and/or increasing the risk of accidents. The lack of a system that can continuously update and predict the location of sound sources (target vehicles) creates additional challenges, making it difficult for drivers to react appropriately and efficiently in complex auditory environments.

Technical Solution: The present system addresses the problem of identifying the direction and location of external sounds by utilizing one or more sensors and one or more processors that may continuously or periodically monitor for external noises, such as sirens or vehicle crashes. Upon detecting a sound, the system processes the external sound to determine the direction and location of the source vehicle relative to the host vehicle. The system then generates a visual display on the host vehicle's screen, showing the sound source's direction, location, and continuously updates position of the target vehicle/source of the external sound. Additionally, the system predicts the future location of the sound source and provides an alert, allowing the vehicle/a driver of the vehicle to respond appropriately. The system may also recommend or initiate an action in the host vehicle based on the predicted movements of the target vehicle, improving reaction time and path clearance for target vehicles in dynamic traffic situations. In addition, the system continuously updates the position of the target vehicle and predicts its future location, identifying the interaction location where the host and target vehicles' paths may intersect. To prevent possible collisions at this interaction location, the system automatically provides resistance to the host vehicle's movement when nearing these areas, helping to avoid hazards proactively.

Technical Result: The present system significantly enhances the response of the host vehicles by providing real-time information about the direction and location of external sounds of the target vehicle, such as emergency vehicle sirens. By continuously tracking and predicting the target vehicle's movements based on the external sound, the system allows drivers to make informed decisions more quickly. This may result in safe driving behavior, especially in situations involving emergency vehicles, by helping the driver avoid unintended movements or interaction with the target vehicle. By determining the direction and position of external sounds and identifying the interaction location between the host and target vehicles, the present system also reduces the risk of collisions, particularly in situations involving emergency or fast-moving vehicles. Further, the automatic resistance applied to the host vehicle helps prevent the driver from unintentionally moving into a collision path, enhancing the overall responsiveness in high-risk traffic scenarios.

Technical Details Specific to the Technical Solution: The technical aspects of the present disclosure include several key components to detect and track a target vehicle. Frequency analysis and pattern recognition are used to classify external sounds, such as emergency vehicle sirens, and localize their source through an array of strategically placed microphones. By applying time difference of arrival (TDOA), the angular position of the external sound, enhanced by frequency-specific properties, intensity variations, and phase differences is calculated. By implementing doppler shift analysis, frequency changes are detected to determine whether the target vehicle is approaching or moving away and assess signal strength to estimate proximity. Kalman filtering is applied to predict the future location of the target vehicle, combining real-time data on the vehicle's position, speed, and direction, while accounting for sensor noise and environmental conditions. Additionally, predefined rules are applied to determine appropriate actions, such as recommending or executing steering corrections or speed adjustments, to ensure safe interaction with the target vehicle.

How Technical Solution is a Technological Advancement: The technical solution advances vehicle safety by detecting and tracking external sounds in real-time and providing continuous updates on the direction and location of sound sources such as emergency vehicles. The technical solution eliminates the need for drivers to rely solely on auditory perception, which can be unreliable in noisy traffic environments. By predicting the future movements of sound sources and displaying their location on the vehicle's screen, the technical solution enhances overall traffic safety. Additionally, the technical solution can predict the path of a target vehicle and calculate potential interaction locations by automatically applying resistance to the host vehicle's movement to avoid collisions.

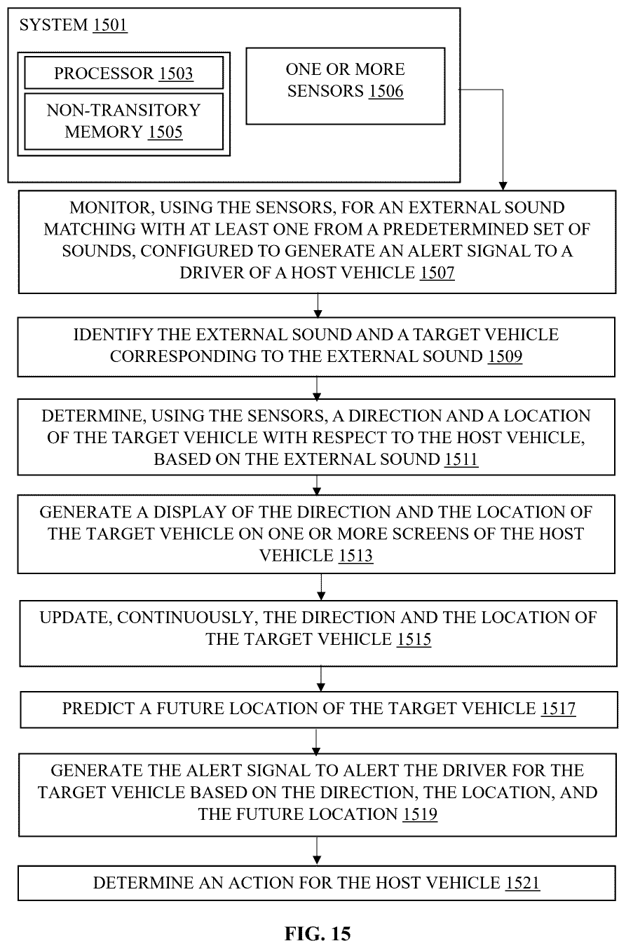

As an example, FIG. 15 illustrates a system 1501 for identifying a direction of external sound and determining an action according to one or more embodiments. The system 1501 comprises: one or more sensors 1506; and a processor 1503. The processor 1503 storing instructions in a non-transitory memory 1505 that, when executed, cause the processor 1503 to: monitor, using the sensors 1506, for an external sound matching with at least one from a predetermined set of sounds, configured to generate an alert signal to a driver of a host vehicle at step 1507; identify the external sound and a target vehicle corresponding to the external sound at step 1509; determine, using the sensors, a direction and a location of the target vehicle with respect to the host vehicle, based on the external sound at step 1511; generate a display of the direction and the location of the target vehicle on one or more screens of the host vehicle at step 1513; update, continuously, the direction and the location of the target vehicle at step 1515; predict a future location of the target vehicle at step 1517; generate the alert signal to alert the driver for the target vehicle based on the direction, the location, and the future location of the target vehicle at step 1519; and determine an action for the host vehicle at step 1521.

In an embodiment of the system, the sensors comprise one or more of a microphone, an acoustic sensor, an ultrasonic sensor, a vibrations sensor, a pressure sensor, a radar sensor, and a LiDAR sensor.

In an embodiment of the system, the external sound comprises a siren; and the siren comprises a pattern associated with one or more of an ambulance, a fire truck, an emergency vehicle, and a police vehicle.

In an embodiment of the system, the alert signal comprises one or more of a visual cue and an auditory cue. In an embodiment of the system, the alert signal is generated on the display, and the display comprises one or more of a smartphone display and a dashboard display. In an embodiment of the system, the system comprises a machine learning module configured to identify the external sound; and identifying the external sound comprises identifying a sound type associated with the target vehicle based on predefined acoustic characteristics.

In an embodiment of the system, the machine learning module continuously updates the predefined acoustic characteristics based on historical sound data and new data comprising environmental conditions to improve an accuracy of identification of the external sound.

In an embodiment of the system, the machine learning module adjusts the sensitivity of detection of the external sound based on a current environmental noise level.

In an embodiment of the system, the system utilizes a frequency analysis and a pattern recognition algorithm to distinguish between the external sound and ambient noise, and the pattern recognition algorithm uses a combination of amplitude modulation, frequency modulation, and temporal sequence analysis.

In an embodiment of the system, the system further enhances the sensors upon identifying the external sound, and enhancing the sensors comprises one or more of adjusting scan frequency, adjusting signal focus, adjusting focus on specific frequency bands, adjusting sensitivity of the sensors, adjusting resolution of the sensors, adjusting Automatic Gain Control of the sensors, adjusting real-time noise reduction, and dynamically adding and deleting sensors for multi-modal sensor fusion.

In an embodiment of the system, the direction comprises an angle of the external sound.

In an embodiment of the system, displaying the direction of the target vehicle comprises displaying the angle in one of front left quadrant, front right quadrant, rear right quadrant, and rear left quadrant.

In an embodiment of the system, the location comprises a distance of the target vehicle from the host vehicle.

In an embodiment of the system, displaying the location of the target vehicle comprises displaying the distance of the target vehicle from the host vehicle.

In an embodiment of the system, the screens of the host vehicle comprise heads-up display of an infotainment system.

In an embodiment of the system, updating the direction and the location of the target vehicle is at a predetermined time interval.

In an embodiment of the system, the future location of the target vehicle is predicted based on one or more of a destination of the target vehicle, a path of the target vehicle, a current speed of the target vehicle, a current heading vector of the target vehicle, and current traffic data.

In an embodiment of the system, the action comprises one or more of a first change in speed of the host vehicle, and a second change of a lane of the host vehicle.

In an embodiment of the system, the first change in the speed of the host vehicle comprises one of reducing the speed and increasing the speed; and the second change in the lane comprises moving from a current lane to another lane.

In an embodiment of the system, the action further comprises changing a route of the host vehicle.

In an embodiment of the system, the host vehicle prioritizes the action based on an urgency determined based on a characteristic of the external sound, and the characteristic comprising one or more of a pattern, a frequency modulation, a volume intensity, and type of the target vehicle.

In an embodiment of the system, the system further comprises a user interface configured to allow a manual override of the action associated with the external sound. The user interface may comprise visual displays, touchscreens, buttons, voice commands, or other input/output devices within the host vehicle, enabling the driver to monitor external sounds, monitor target vehicle information, and take control of certain system functions. The override may be automatic or manual. This capability gives the driver full control over the vehicle's actions, such as changing speed or lane, despite any automatic recommendations or actions provided by the system based on the detected external sound.

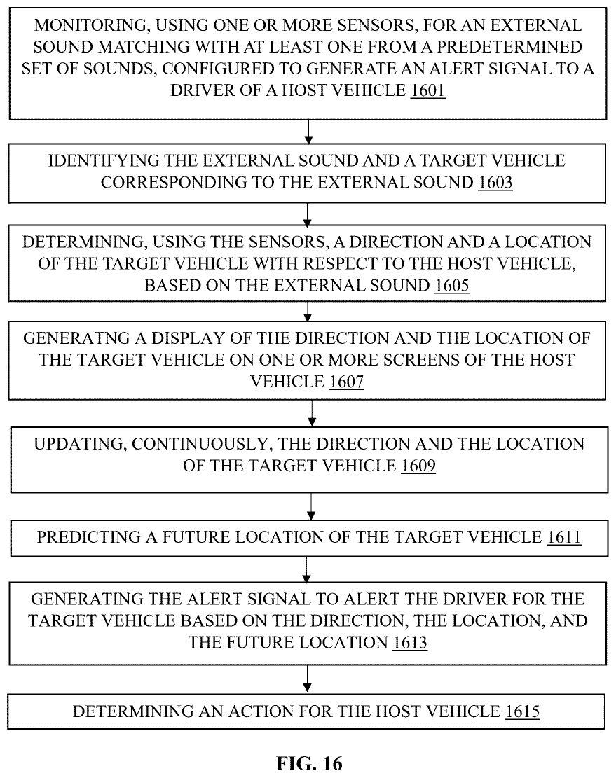

In one aspect, a method is described. As an example, FIG. 16 illustrates a method of identifying the direction of external sound and determining action according to one or more embodiments. The method comprises the following technical steps: monitoring, using one or more sensors, for an external sound matching with at least one from a predetermined set of sounds, configured to generate an alert signal to a driver of a host vehicle at step 1601; identifying the external sound and a target vehicle corresponding to the external sound at step 1603; determining, using the sensors, a direction and a location of the target vehicle with respect to the host vehicle, based on the external sound at step 1605; generating a display of the direction and the location of the target vehicle on one or more screens of the host vehicle at step 1607; updating, continuously, the direction and the location of the target vehicle at step 1609; predicting a future location of the target vehicle at step 1611; generating the alert signal to alert the driver for the target vehicle based on the direction, the location, and the future location of the target vehicle at step 1613; and determining an action for the host vehicle at step 1615. In an embodiment of the method, the sensors comprise one or more of a microphone, an acoustic sensor, an ultrasonic sensor, a vibrations sensor, a pressure sensor, a radar sensor, and a LiDAR sensor.

In an embodiment of the method, the external sound comprises a siren; and the siren comprises a pattern associated with one or more of an ambulance, a fire truck, an emergency vehicle, and a police vehicle.

In an embodiment of the method, the future location of the target vehicle is predicted, using a route prediction module, based on one or more of the destination of the target vehicle, the path of the target vehicle, a current speed of the target vehicle, a current heading vector of the target vehicle, and current traffic data.

In an embodiment of the method, the future location of the target vehicle is predicted based on a communication by the target vehicle with the host vehicle. In an embodiment of the method, the host vehicle prioritizes the action based on an urgency determined based on a characteristic of the external sound.

In an embodiment of the method, the characteristic comprises one or more of a pattern, a frequency modulation, a volume intensity, and type of the target vehicle.

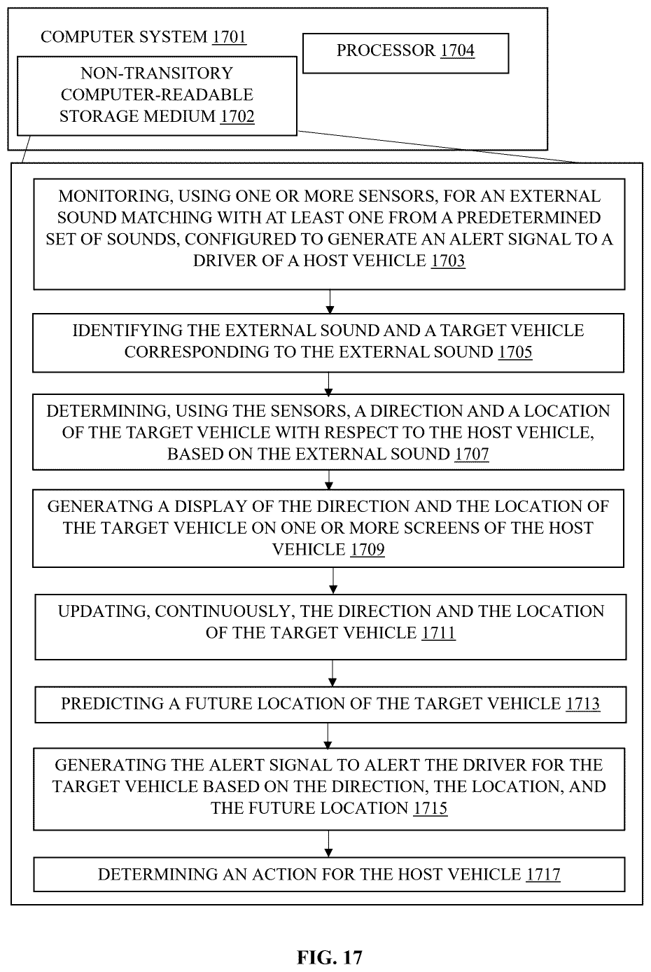

As an example, FIG. 17 illustrates a method, stored in a non-transitory computer-readable storage medium 1702, in a block diagram for identifying direction of external sound and determining an action according to one or more embodiments. According to an embodiment, disclosed is a computer system 1701 comprising the non-transitory computer-readable storage medium 1702 having stored thereon instructions executable by a processor 1704 to perform operations comprising: monitoring, using one or more sensors, for an external sound matching with at least one from a predetermined set of sounds, configured to generate an alert signal to a driver of a host vehicle at step 1703; identifying the external sound and a target vehicle corresponding to the external sound at step 1705; determining, using the sensors, a direction and a location of the target vehicle with respect to the host vehicle, based on the external sound at step 1707; generating a display of the direction and the location of the target vehicle on one or more screens of the host vehicle at step 1709; updating, continuously, the direction and the location of the target vehicle at step 1711; predicting a future location of the target vehicle at step 1713; generating the alert signal to alert the driver for the target vehicle based on the direction, the location, and the future location of the target vehicle at step 1715; and determining an action for the host vehicle at step 1717.

In an embodiment of the method, the sensors comprise one or more of a microphone, an acoustic sensor, an ultrasonic sensor, a vibrations sensor, a pressure sensor, a radar sensor, and a LiDAR sensor.

In an embodiment of the method, the external sound comprises a siren; and the siren comprises a pattern associated with one or more of an ambulance, a fire truck, an emergency vehicle, and a police vehicle. In an embodiment of the method, the future location of the target vehicle is predicted, using a route prediction module, based on one or more of a destination of the target vehicle, a path of the target vehicle, a current speed of the target vehicle, a current heading vector of the target vehicle, and current traffic data. In an embodiment of the method, the host vehicle communicates with neighboring vehicles to determine the action.

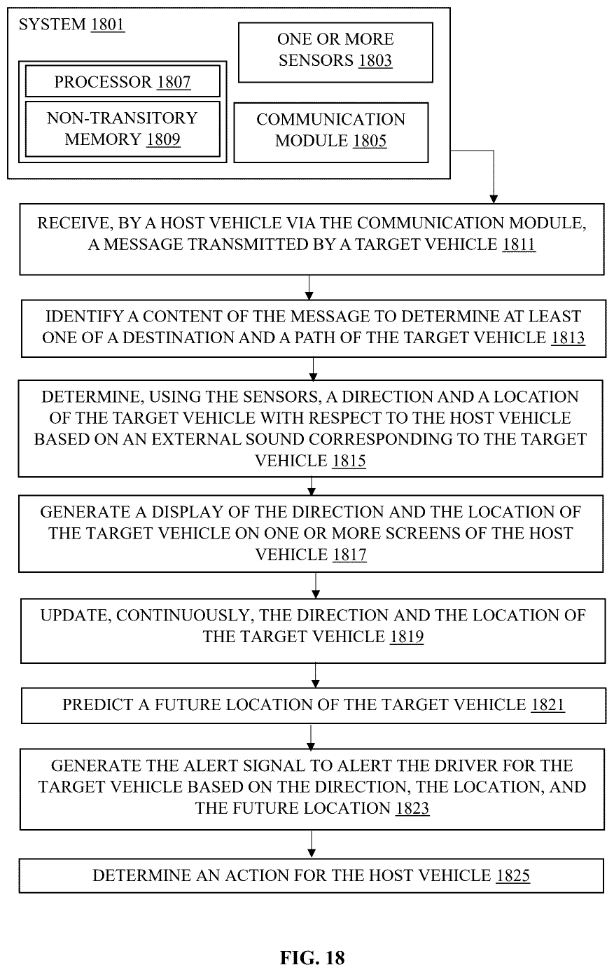

In an aspect, a system is described. As an example, FIG. 18 illustrates a system 1801 for communicating a message to a host vehicle by a target vehicle and determining an action, according to one or more embodiments. System 1801 comprises: one or more sensors 1803; a communication module 1805; and a processor 1807. The processor 1807 storing instructions in a non-transitory memory 1809 that, when executed, cause the processor 1807 to: receive, by a host vehicle via the communication module 1805, a message transmitted by a target vehicle at step 1811; identify a content of the message to determine at least one of a destination and a path of the target vehicle at step 1813; determine, using the sensors 1803, a direction and a location of the target vehicle with respect to the host vehicle based on an external sound corresponding to the target vehicle at step 1815; generate a display of the direction and the location of the target vehicle on one or more screens of the host vehicle at step 1817; update, continuously, the direction and the location of the target vehicle at step 1819; predict a future location of the target vehicle at step 1821; generate an alert signal to alert a driver of the host vehicle based on the direction, the location, and the future location of the target vehicle at step 1823; and determine an action for the host vehicle at step 1825.

In an embodiment of the system, the sensors 1803 comprise one or more of a microphone, an acoustic sensor, an ultrasonic sensor, a vibrations sensor, a pressure sensor, a radar sensor, and a LiDAR sensor. In an embodiment of the system, the message further comprises one or more of the direction of the target vehicle, and the location of the target vehicle. In an embodiment of the system, the external sound comprises a siren; and the siren comprises a pattern associated with one or more of an ambulance, a fire truck, an emergency vehicle, and a police vehicle. In an embodiment of the system, the future location of the target vehicle is predicted, using a route prediction module, based on one or more of the destination of the target vehicle, the path of the target vehicle, and current traffic data, a current speed of the target vehicle and a heading vector of the target vehicle. A Natural Language Processing model may be used for identifying the content of the message. The host vehicle action may comprise one or more of changing a speed, changing a lane, and changing a route of the host vehicle.

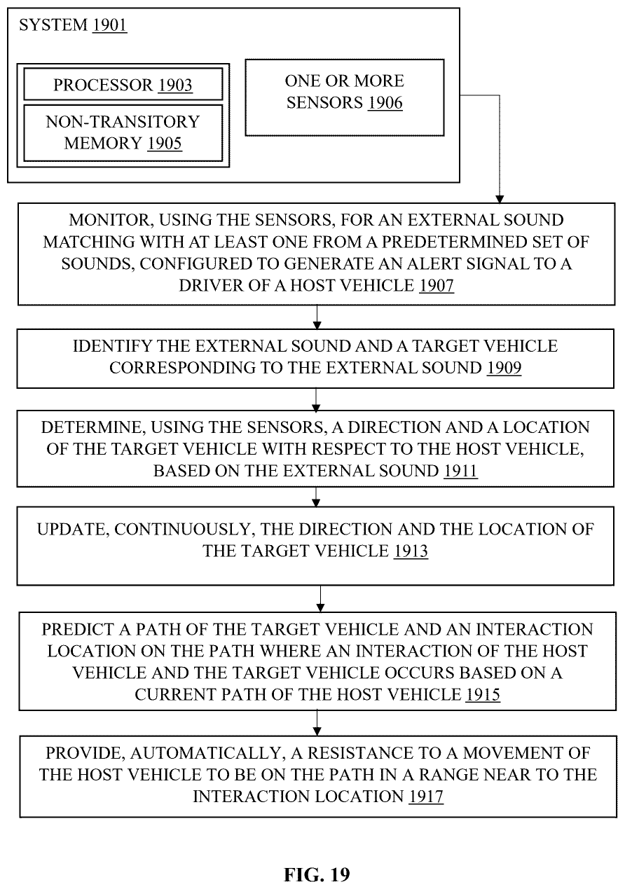

As an example, FIG. 19 illustrates a system 1901 of identifying direction of external sound and performing action, according to one or more embodiments. The system 1901 comprises: one or more sensors 1906 and a processor 1903. The processor 1903 storing instructions in a non-transitory memory 1905 that, when executed, cause the processor 1903 to: monitor, using the sensors 1906, for an external sound matching with at least one from a predetermined set of sounds, configured to generate an alert signal to a driver of a host vehicle at step 1907; identify the external sound and a target vehicle corresponding to the external sound at step 1909; determine, using the sensors 1906, a direction and a location of the target vehicle with respect to the host vehicle, based on the external sound at step 1911; update, continuously, the direction and the location of the target vehicle at step 1913; predict a path of the target vehicle and an interaction location on the path where an interaction of the host vehicle and the target vehicle occurs based on a current path of the host vehicle at step 1915; and provide, automatically, a resistance to a movement of the host vehicle to be on the path in a range near to the interaction location at step 1917.

In an embodiment of the system, the sensors 1906 comprises one or more of microphones, acoustic sensors, ultrasonic sensors, vibrations sensors, pressure sensors, radar sensors, and LiDAR sensors. In an embodiment of the system, the external sound comprises a siren; and the siren comprises a pattern associated with one or more of an ambulance, a fire truck, an emergency vehicle, and a police vehicle.

In an embodiment of the system, the system 1901 continuously tracks the target vehicle using the external sound via the sensors. The alert signal may comprise one or more of a visual cue and an auditory cue. In an embodiment of the system, the system 1901 comprises a machine learning module configured to identify the external sound; and identifying the external sound comprises identifying a sound type associated with the target vehicle based on predefined acoustic characteristics.

In an embodiment of the system, the machine learning module continuously updates predefined acoustic characteristics based on historical sound data and new data comprising environmental conditions to improve an accuracy of identification of the external sound. In an embodiment of the system, the machine learning module adjusts a sensitivity of detection of the external sound based on a current environmental noise level. In an embodiment of the system, the system 1901 utilizes a frequency analysis and a pattern recognition algorithm to distinguish between the external and ambient noise, the pattern recognition algorithm uses a combination of amplitude modulation, frequency modulation, and temporal sequence analysis. The system 1901 may enhance the sensors upon identifying the external sound, and enhancing the sensors comprises one or more of adjusting scan frequency, adjusting signal focus, adjusting focus on specific frequency bands, adjusting sensitivity of the sensors, adjusting resolution of the sensors, adjusting Automatic Gain Control of the sensors, adjusting real-time noise reduction, and dynamically adding and deleting sensors for multi-modal sensor fusion.

In an embodiment of the system, the direction comprises an angle of the external sound. In an embodiment of the system, displaying the direction of the target vehicle comprises displaying the angle in one of front left quadrant, front right quadrant, rear right quadrant, and rear left quadrant. The location may comprise a distance of the target vehicle from the host vehicle. In an embodiment of the system, displaying the location of the target vehicle comprises displaying the distance of the target vehicle from the host vehicle. The host vehicle may detect an urgency based on a characteristic of the external sound, and the characteristic comprises one or more of a pattern, a frequency modulation, a volume intensity, and type of the target vehicle. The alert signal may be generated on a display, and the display comprises one or more of a smartphone display and a dashboard display.

In an embodiment of the system, updating the direction and the location of the target vehicle is at a predetermined time interval. In an embodiment of the system, the path is predicted based on one or more of a destination of the target vehicle, a current speed of the target vehicle, a current heading vector of the target vehicle, and a current traffic data.

In an embodiment of the system, the interaction location is predicted based on the path of the target vehicle, a current speed of the target vehicle, a current heading vector of the target vehicle, a current speed of the host vehicle, a heading vector of the host vehicle, a path of the host vehicle, and current traffic data. In an embodiment of the system, the system 1901 further determines time points for the interaction location.

In an embodiment of the system, the resistance to the movement of the host vehicle is provided by automatically performing steering corrections. In an embodiment of the system, the resistance to the movement of the host vehicle is provided by providing torque feedback on a steering wheel of the host vehicle making the steering wheel physically harder for the driver to turn. In an embodiment of the system, the resistance to the movement of the host vehicle is provided by employing selective braking on a side to create a pulling force to keep the host vehicle in a current lane. In an embodiment of the system, the range near to the interaction location is 10 meters to 100 meters.

The alert signal may be generated on a display and the display comprises one or more of a smartphone display and a dashboard display of the host vehicle. In an embodiment of the system, the system 1901 further generates an action comprising a change in speed of the host vehicle, and the change in the speed comprises one of reducing the speed and increasing the speed. In an embodiment of the system, the action further comprises a change in a lane, and the change in the lane comprises moving from one current lane to another lane. The action may comprise a change in the route of the host vehicle. In an embodiment of the system, the system 1901 further comprises a user interface configured to allow a manual override for the resistance to the movement of the host vehicle.

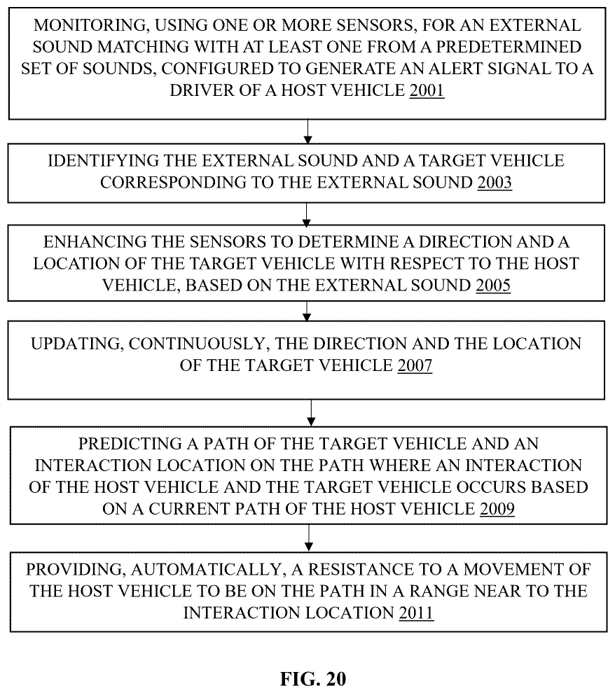

As an example, FIG. 20 illustrates a method for identifying direction of external sound and performing an action according to one or more embodiments. The method comprises the following technical steps: monitoring, using one or more sensors, for an external sound matching with at least one from a predetermined set of sounds, configured to generate an alert signal to a driver of a host vehicle at step 2001; identifying the external sound and a target vehicle corresponding to the external sound at step 2003; enhancing the sensors to determine a direction and a location of the target vehicle with respect to the host vehicle, based on the external sound at step 2005; updating, continuously, the direction and the location of the target vehicle at step 2007; predicting a path of the target vehicle and an interaction location on the path where an interaction of the host vehicle and the target vehicle occurs based on a current path of the host vehicle at step 2009; and providing, automatically, a resistance to a movement of the host vehicle to be on the path in a range near to the interaction location at step 2011.

In an embodiment of the method, the sensors comprise one or more of microphones, acoustic sensors, ultrasonic sensors, vibrations sensors, pressure sensors, radar sensors, and LiDAR sensors. In an embodiment of the method, the external sound comprises a siren; and the siren comprises a pattern associated with one or more of an ambulance, a fire truck, an emergency vehicle, and a police vehicle. In an embodiment of the method, the method comprises a machine learning module configured to identify the external sound; and identifying the external sound comprises identifying a sound type associated with the target vehicle based on predefined acoustic characteristics.

In an embodiment of the method, the machine learning module continuously updates predefined acoustic characteristics based on historical sound data and new data comprising environmental conditions to improve an accuracy of identification of the external sound.

The machine learning module may continuously update predefined acoustic characteristics based on historical sound data and new data comprising environmental conditions to improve an accuracy of identification of the external sound. In an embodiment of the method, the method utilizes a frequency analysis and a pattern recognition algorithm to distinguish between the external sound and ambient noise, the pattern recognition algorithm uses a combination of amplitude modulation, frequency modulation, and temporal sequence analysis.

In an embodiment of the method, the interaction location is predicted based on the path of the target vehicle, a current speed of the target vehicle, a current heading vector of the target vehicle, a current speed of the host vehicle, a current heading vector of the host vehicle, a path of the host vehicle, and a current traffic data. In an embodiment of the method, the resistance to the movement of the host vehicle is provided by one of automatically performing steering corrections, provide torque feedback on a steering wheel of the host vehicle making the steering wheel physically harder for the driver to turn, by employing selective braking on a side to create a pulling force to keep the host vehicle in a current lane.

In an embodiment of the method, the method further generates an action comprising a change in speed of the host vehicle, and the change in the speed comprises one of reducing the speed and increasing the speed.

In an embodiment of the method, the action further comprises a change in a lane, and the change in the lane comprises moving from a current lane to another lane. The action may comprise changing a route of the host vehicle.

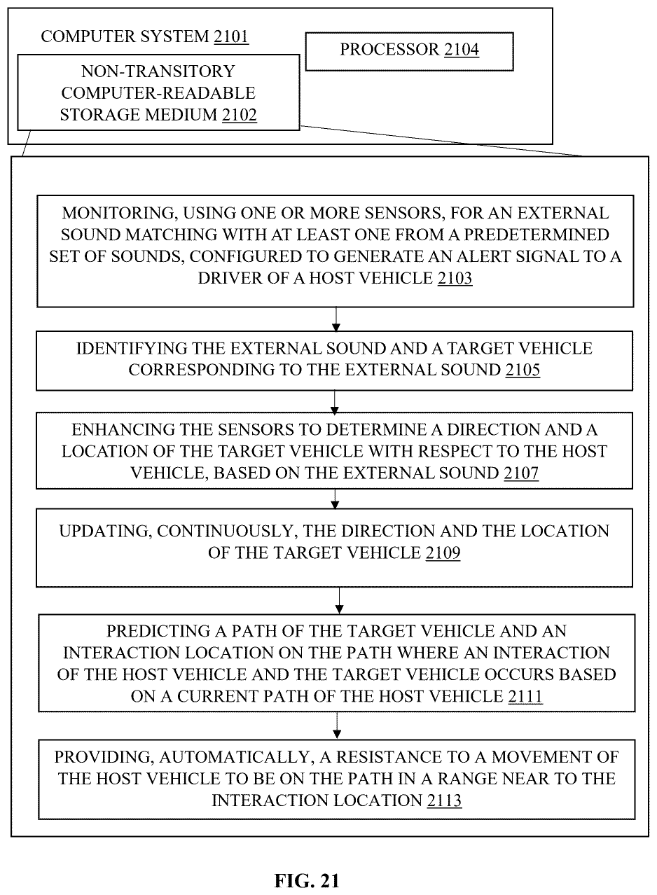

As an example, FIG. 21 illustrates a non-transitory computer-readable storage medium 2102 for identifying direction of external sound and performing action according to one or more embodiments. According to an embodiment, disclosed is a computer system 2101 comprising the non-transitory computer-readable storage medium 2102 having stored thereon instructions executable by a processor 2104 to perform operations comprising: monitoring, using one or more sensors, for an external sound matching with at least one from a predetermined set of sounds, configured to generate an alert signal to a driver of a host vehicle at step 2103; identifying the external sound and a target vehicle corresponding to the external sound at step 2105; enhancing the sensors to determine a direction and a location of the target vehicle with respect to the host vehicle, based on the external sound at step 2107; updating, continuously, the direction and the location of the target vehicle at step 2109; predicting a path of the target vehicle and an interaction location on the path where an interaction of the host vehicle and the target vehicle occurs based on a current path of the host vehicle at step 2111; and providing, automatically, a resistance to a movement of the host vehicle to be on the path in a range near to the interaction location at step 2113.

In an embodiment of the method, the sensors comprise one or more of microphones, acoustic sensors, ultrasonic sensors, vibrations sensors, pressure sensors, radar sensors, and LiDAR sensors. In an embodiment of the method, the external sound comprises a siren; and the siren comprises a pattern associated with one or more of an ambulance, a fire truck, an emergency vehicle, and a police vehicle. In an embodiment of the method, the interaction location is predicted based on the path of the target vehicle, a current speed of the target vehicle, a current heading vector of the target vehicle, a current speed of the host vehicle, a current heading vector of the host vehicle, a path of the host vehicle, and a current traffic data. In an embodiment of the method, the resistance to the movement of the host vehicle is provided by one of automatically performing steering corrections, provide torque feedback on a steering wheel of the host vehicle making the steering wheel physically harder for the driver to turn, by employing selective braking on a side to create a pulling force to keep the host vehicle in a current lane.

In an embodiment of the method, the operations are further configured to generate an action comprising a change in speed of the host vehicle, and the change in the speed comprises one of reducing the speed and increasing the speed. The action may comprise a change in a lane, and the change in the lane comprises moving from a current lane to another lane. In an embodiment of the method, the action further comprises changing a route of the host vehicle.

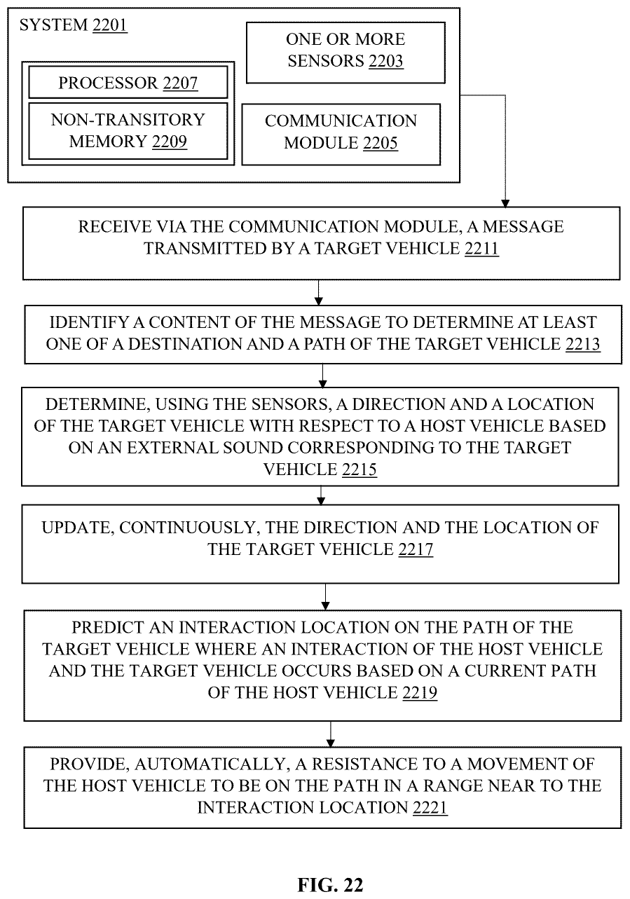

In an aspect, a system is described. As an example, FIG. 22 illustrates a system 2201 for communicating a message to a host vehicle by a target vehicle and performing an action, according to one or more embodiments. The system 2201 comprises: one or more sensors 2203; a communication module 2205; and a processor 2207. The processor 2207 storing instructions in a non-transitory memory 2209 that, when executed, cause the processor 2207 to: receive via the communication module 2205, a message transmitted by a target vehicle at step 2211; identify a content of the message to determine at least one of a destination and a path of the target vehicle at step 2213; determine, using the sensors 2203, a direction and a location of the target vehicle with respect to a host vehicle based on an external sound corresponding to the target vehicle at step 2215; update, continuously, the direction and the location of the target vehicle at step 2217; predict an interaction location on the path of the target vehicle where an interaction of the host vehicle and the target vehicle occurs based on a current path of the host vehicle at step 2219; and provide, automatically, a resistance to a movement of the host vehicle to be on the path in a range near to the interaction location at step 2221.

In an embodiment of the system, the sensors comprise one or more of microphones, acoustic sensors, ultrasonic sensors, vibrations sensors, pressure sensors, radar sensors, and LiDAR sensors. In an embodiment of the system, the message further comprises one or more of the direction of the target vehicle, and the location of the target vehicle. In an embodiment of the system, a Natural Language Processing model is used for identifying the content of the message. The external sound may comprise a siren; and the siren comprises a pattern associated with one or more of an ambulance, a fire truck, an emergency vehicle, and a police vehicle.

The path of the target vehicle may be monitored and updated, using a route prediction module, based on one or more of the destination of the target vehicle, a current speed of the target vehicle, a heading vector of the target vehicle, and current traffic data.

In an embodiment of the system, the interaction location is predicted based on the path of the target vehicle, a current speed of the target vehicle, a current heading vector of the target vehicle, a current speed of the host vehicle, a current heading vector of the host vehicle, and a current traffic data.

In an embodiment of the system, the range near to the interaction location is 10 meters to 100 meters. In an embodiment of the system, the resistance to the movement of the host vehicle is provided by one of automatically performing steering corrections, providing torque feedback on a steering wheel of the host vehicle making the steering wheel physically harder for a driver to turn, by employing selective braking on a side to create a pulling force to keep the host vehicle in a current lane.

The system may comprise a user interface configured to allow a manual override for the resistance to the movement of the host vehicle.

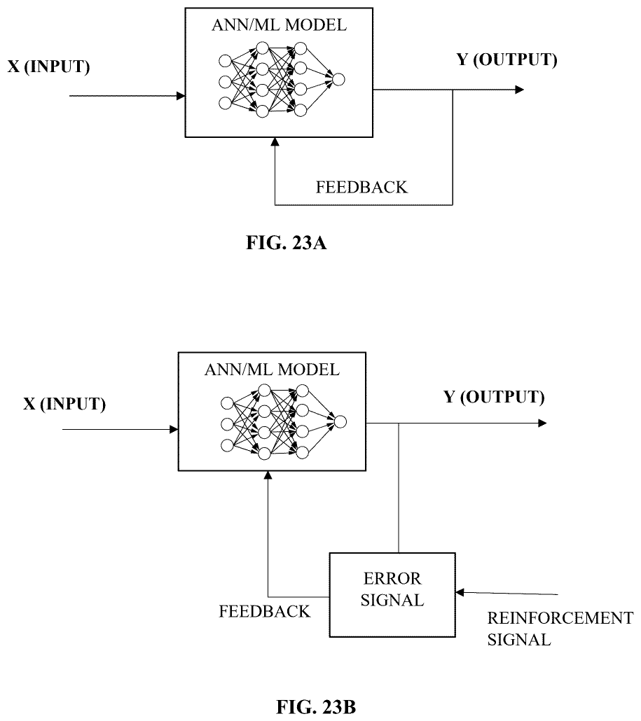

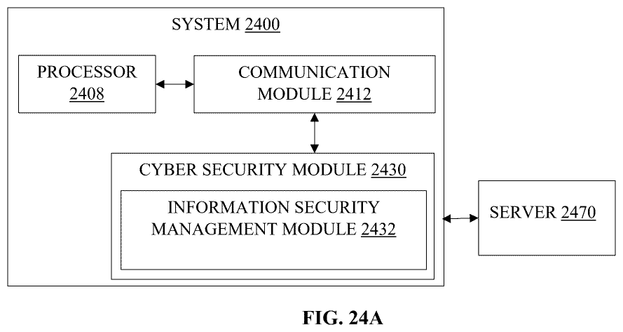

As an example, FIG. 23A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may identify direction of external sound and determine action.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labeled data and concepts, after a while, the models' performance may decline while adding new, unlabeled input due to many reasons which comprise, but not limited to, concept drift, recall precision degradation due to drifting away from true positives, and data drift over time. A feedback loop in the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (for e.g., identifying direction of external sound and determining action, etc.) are used that are meant for the model to learn. Afterward, the model is tested using unlabeled data. By using, for example, deep learning and neural networks, the model can then make predictions on whether the desired concept/s (for e.g., identifying direction of external sound and determining action, etc.) are in unlabeled images. Each image is given a probability score where higher scores represent a higher level of confidence in the models' predictions. Where a model gives an image with a high probability score, it is auto labeled with the predicted concept. However, in the cases where the model returns a low probability score, this input may be sent to a controller (may be a human moderator) which verifies and, as necessary, corrects the result. The human moderator may be used only in exception cases. The feedback loop feeds labeled data, auto labeled or controller-verified, back to the model dynamically and is used as training data so that the system can improve its predictions in real-time and dynamically.

As an example, FIG. 23B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priority of the messages is evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging stations and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

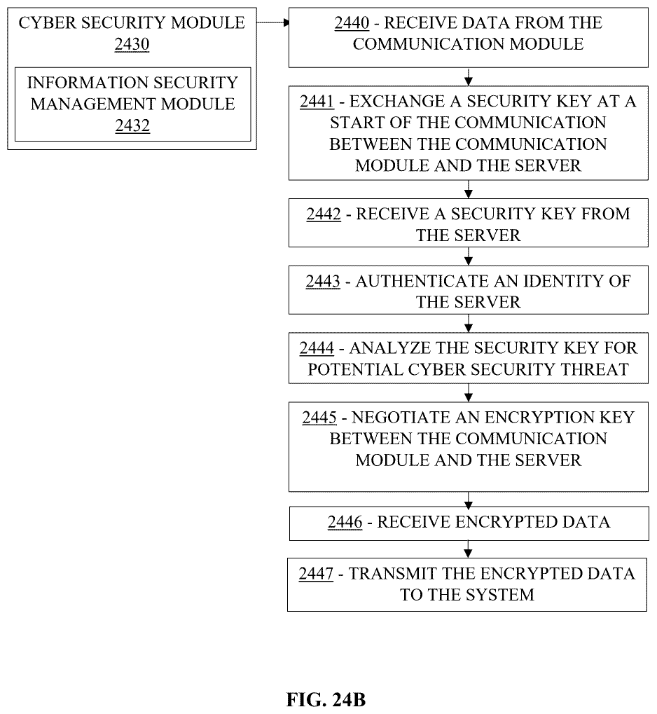

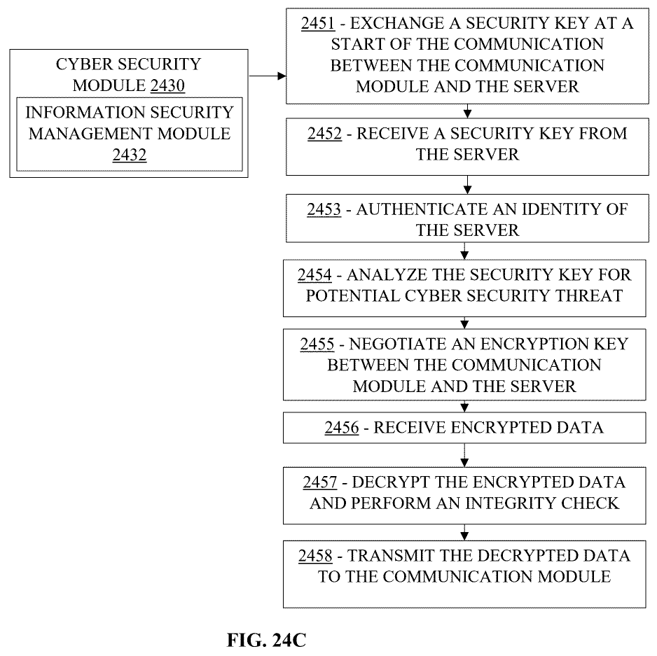

In an embodiment, FIG. 24A shows the block diagram of the cyber security module. The communication of data between the system 2400 and the server 2470, through the processor 2408, through the communication module 2412, is first verified by the information security management module 2432 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 24B shows the flowchart of securing the data through the cyber security module 2430. At step 2440, the information security management module 2432 is operable to receive data from the communication module. At step 2441, the information security management module exchanges a security key at a start of the communication between the communication module and the server. At step 2442, the information security management module receives a security key from the server. At step 2443, the information security management module authenticates an identity of the server by verifying the security key. At step 2444, the information security management module analyzes the security key for potential cyber security threats. At step 2445, the information security management module negotiates an encryption key between the communication module and the server. At step 2446, the information security management module receives the encrypted data. At step 2447, the information security management module transmits the encrypted data to the server when no cyber security threat is detected.

In an embodiment, FIG. 24C shows the flowchart of securing the data through the cyber security module 2430. At step 2451, the information security management module 2432 is operable to: exchange a security key at a start of the communication between the communication module and the server. At step 2452, the information security management module receives a security key from the server. At step 2453, the information security management module authenticates an identity of the server by verifying the security key. At step 2454, the information security management module analyzes the security key for potential cyber security threats. At step 2455, the information security management module negotiates an encryption key between the communication module and the server. At step 2456, the information security management module receives encrypted data. At step 2457, the information security management module decrypts the encrypted data, and performs an integrity check of the decrypted data. At step 2458, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 24A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting a Rivest-Shamir-Adleman (RSA) encryption algorithm. RSA is a public key cryptosystem that is widely used for secure data transmission. The negotiated keys comprise a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present disclosure without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-42. (canceled)

43. A system comprising:
one or more sensors; and
a processor;
wherein the processor storing instructions in a non-transitory memory that, when executed, cause the processor to:
monitor, using the sensors, for an external sound matching with at least one from a predetermined set of sounds, configured to generate an alert signal to a driver of a host vehicle;
identify the external sound and a target vehicle corresponding to the external sound;
determine, using the sensors a direction and a location of the target vehicle with respect to the host vehicle, based on the external sound;
generate a display of the direction and the location of the target vehicle on one or more screens of the host vehicle;
update, continuously, the direction and the location of the target vehicle;
predict a future location of the target vehicle;
generate the alert signal to alert the driver for the target vehicle based on the direction, the location, and the future location; and
determine an action for the host vehicle.

44. The system of claim 43, wherein the sensors comprise one or more of microphones, acoustic sensors, ultrasonic sensors, vibrations sensors, pressure sensors, radar sensors, and LiDAR sensors.

45. The system of claim 43, wherein the external sound comprises a siren; and wherein the siren comprises a pattern associated with one or more of an ambulance, a fire truck, an emergency vehicle, and a police vehicle.

46. The system of claim 43, wherein the system comprises a machine learning module configured to identify the external sound; and wherein identifying the external sound comprises identifying a sound type associated with the target vehicle based on predefined acoustic characteristics.

47. The system of claim 46, wherein the machine learning module continuously updates the predefined acoustic characteristics based on historical sound data and new data comprising environmental conditions to improve an accuracy of the identification of the external sound.

48. The system of claim 46, wherein the machine learning module adjusts a sensitivity of detection of the external sound based on a current environmental noise level.

49. The system of claim 43, wherein the system utilizes a frequency analysis and a pattern recognition algorithm to distinguish between the external sound and ambient noise, wherein the pattern recognition algorithm uses a combination of amplitude modulation, frequency modulation, and temporal sequence analysis.

50. The system of claim 43, wherein the system further enhances the sensors upon identifying the external sound, wherein enhancing the sensors comprises one or more of adjusting scan frequency, adjusting signal focus, adjusting focus on specific frequency bands, adjusting sensitivity of the sensors, adjusting resolution of the sensors, adjusting Automatic Gain Control of the sensors, adjusting real-time noise reduction, and dynamically adding and deleting sensors for multi-modal sensor fusion.

51. The system of claim 43, wherein the future location of the target vehicle is predicted based on one or more of a destination of the target vehicle, a path of the target vehicle, a current speed of the target vehicle, a current heading vector of the target vehicle, and current traffic data.

52. The system of claim 43, wherein the action comprises one or more of a first change in speed of the host vehicle, and a second change of a lane of the host vehicle.

53. The system of claim 52, wherein the first change in the speed of the host vehicle comprises one of reducing the speed and increasing the speed; and wherein the second change in the lane comprises moving from a current lane to another lane.

54. The system of claim 43, wherein the action further comprises changing a route of the host vehicle.

55. The system of claim 43, wherein the host vehicle prioritizes the action based on an urgency determined based on a characteristic of the external sound, wherein the characteristic comprises one or more of a pattern, a frequency modulation, a volume intensity, and type of the target vehicle.

56. A method comprising:
monitoring, using one or more sensors, for an external sound matching with at least one from a predetermined set of sounds, configured to generate an alert signal to a driver of a host vehicle;
identifying the external sound and a target vehicle corresponding to the external sound;
determining, using the sensors, a direction and a location of the target vehicle with respect to the host vehicle, based on the external sound;
generating a display of the direction and the location of the target vehicle on one or more screens of the host vehicle;
updating, continuously, the direction and the location of the target vehicle;
predicting a future location of the target vehicle;
generating the alert signal to alert the driver for the target vehicle based on the direction, the location, and the future location of the target vehicle; and
determining an action for the host vehicle.

57. The method of claim 56, wherein the future location of the target vehicle is predicted, using a route prediction module, based on one or more of a destination of the target vehicle, a path of the target vehicle, a current speed of the target vehicle, a current heading vector of the target vehicle, and current traffic data.

58. The method of claim 56, wherein the future location of the target vehicle is predicted based on a communication by the host vehicle with the target vehicle.

59. A non-transitory computer-readable storage medium having stored thereon instructions executable by a computer system to perform operations comprising:
monitoring, using one or more sensors, an external sound matching with at least one from a predetermined set of sounds, configured to generate an alert signal to a driver of a host vehicle;
identifying one of the external sound and a target vehicle corresponding to the external sound;
determining, using the sensors, a direction and a location of the target vehicle with respect to the host vehicle, based on the external sound;
generating a display of the direction and the location of the target vehicle on one or more screens of the host vehicle;
updating, continuously, the direction and the location of the target vehicle;
predicting a future location of the target vehicle;
generating the alert signal to alert the driver for the target vehicle based on the direction, the location, and the future location of the target vehicle; and
determining an action for the host vehicle.

60. The non-transitory computer-readable storage medium of claim 59, wherein the direction comprises an angle of the external sound.

61. The non-transitory computer-readable storage medium of claim 60, wherein displaying the direction of the target vehicle comprises displaying the angle in one of front left quadrant, front right quadrant, rear right quadrant, and rear left quadrant.

62. The non-transitory computer-readable storage medium of claim 59, wherein the host vehicle communicates with neighboring vehicles to determine the action.
